(19) United States
(12) Patent Application Publication
(10) Pub. No.: US 2025/0356080 A1
(43) Pub. Date: Nov. 20, 2025

(54) ELECTRICAL FAULT AND POWER QUALITY MONITORING USING DISTRIBUTED LEDGER TECHNOLOGY

(71) Applicant: UT-Battelle, LLC, Oak Ridge, TN (US)

(72) Inventors: Emilio Carlos Piesciorovsky, Oak Ridge, TN (US); Gary Hahn, Loudon, TN (US); Aaron William Werth, Knoxville, TN (US); Raymond Charles Borges Hink, Knoxville, TN (US)

(21) Appl. No.: 19/207,974

(22) Filed: May 14, 2025

Related U.S. Application Data
(60) Provisional application No. 63/647,782, filed on May 15, 2024.

(51) Int. Cl. G06F 30/20; G06F 113/04; H04L 9/00; H04L 9/06

(52) U.S. Cl. CPC G06F 30/20; H04L 9/0643; H04L 9/50; G06F 2113/04

(57) ABSTRACT

An electrical substation test bed with DLT for multipurpose power system applications. The test bed has a real-time simulator with power meters and protective relays in-the-loop. The test bed is used for DLT applications providing a platform for performing use case scenarios with focus on electrical fault detection, power quality monitoring, DER use cases, and cyber-event scenarios. The grid test bed has a real-time simulator with power meters and protective relays in-the-loop and represents an electrical substation grid with inside and outside IEDs and DERs. Use case scenarios focus on using power meters and protective relays with GOOSE messages, as well as an external timing source for synchronizing the power system applications. This test bed presents the same time stamps for the events from the protective relay and the CGG system, which proved the synchronization of the data managed with the algorithms.

### CROSS REFERENCE TO RELATED APPLICATION

The present application claims benefit of U.S. Provisional Application No. 63/647,782 filed on May 15, 2024, all of the contents of which are incorporated herein by reference.

### STATEMENT REGARDING FEDERALLY SPONSORED RESEARCH OR DEVELOPMENT

This invention was made with government support under project DE-AC05-00OR22725 awarded by the U.S. Department of Energy. The government has certain rights to this invention.

### BACKGROUND

Electrical utilities continue to deploy more types and numbers of intelligent electronic devices (IEDs), such as power meters and protective relays. As the market penetration of distributed energy resources (DERs) increases, so have measurements that rely on communications between IEDs within and outside a substation's perimeter. Currently, the most popular blockchain research applications for electrical utilities are in the field of energy trading. However, utilities have also employed blockchain technology to support new functions that can improve the resilience of the electrical grid. Additionally, researchers are discovering grid management applications that are non-traditional in scope. Dynamic management capabilities are possible with customer owned and managed DERs, as well as the deployment of smart sensors with IEDs. Therefore, numerous new blockchain applications are being developed that focus on control, measurement, and protection.

The integrity and confidentiality of data and control commands between IEDs are crucial. The establishment of and reliance on communications across the utility-customer interface to enhance grid dispatch and control has created a significant threat vector for secure power system operations, such as cyber intrusion and/or communications failures. Also, new scenarios include the dynamism of the energy market with the penetration of DERs and the deployment of sensors with IEDs. This opportunity introduces new players to the energy market, requiring peer-to-peer energy trading in real time. Blockchain technology supports such peer-to-peer trading and thus has injected new vitality into the energy market. Currently, research projects using blockchain technology for distributed photovoltaic power generation and carbon trading are also emerging.

The blockchain applications in the electricity sector can be classified as energy trading; wholesale markets; metering, billing, and retail markets; trading of renewable energy certifications and carbon credits; electric vehicle (EV) charging; power system cyber security enhancements; renewable energy certifications; and grid operation and management. Based on energy trading applications, one study presented a joint operation mechanism of a distributed photovoltaic power generation market and carbon market. This method modeled two chains that enabled the two markets to share data using an improved IEEE 33-bus system based on software simulation. Another source presented a blockchain for transacting energy and carbon allowance in networked microgrids. Also, the blockchain solution algorithm consisted of column-and-constraint generation and Karush-Kuhn-Tucker conditions to solve the two-stage market optimization problems based on using an IEEE 33-bus and the IEEE 123-bus system with a software simulation. Another publication described in detail their research based on a blockchain-based, peer-to-peer, transactive energy system for a community microgrid with demand response management. This system used two types of architectures: one with the third-party agent demonstrated using the MATLAB environment and the other with the virtual agent (without third-party) implemented using a blockchain environment. Another relevant blockchain application was based on cyberattack protection frameworks. A distributed blockchain-based data protection framework for modern power systems against cyberattacks was developed in another source; the effectiveness of this protection framework was demonstrated on the IEEE 118-bus benchmark system with a software simulation. A blockchain-based decentralized replay attack detection for large-scale power systems was based on the use of a software simulation with an IEEE 3012-bus transmission grid.

Additionally, the penetration of DERs is becoming an essential part of smart grid systems and led to the formation of various aggregation mechanisms, such as virtual power plants (VPPs), enabling the participation of small- and medium-scale DERs in electricity markets. One publication presented a blockchain-based, decentralized VPP of small prosumers that used a public blockchain and self-enforcing smart contract to construct a VPP of prosumers to provide energy services based on smart contract algorithms. The blockchain was also studied in electric vehicle (EV) research applications. A smart EV charging station energy management system based on blockchain technology, which aims to protect privacy of EVs users, ensure fairness of power transactions, and meet charging demands for large numbers of EVs, was presented in a study. Another article proposed an artificial intelligence-enabled, blockchain-based EV integration system in a smart grid platform. This system was based on an artificial neural network for EV charge prediction, in which the EV fleet is employed as a consumer and a supplier of electrical energy within a VPP platform.

Many potential energy applications with blockchain were based on software simulations. Although general monitoring for blockchain applications could be evaluated in operational electrical grids, other blockchain research applications such as cyberattack defense and electrical fault detection are not likely to be performed in operational electrical grids because of possible risks to network security, equipment failures, and energy provision.

### SUMMARY

A test bed framework including systems and methods using distributed ledger technology (DLT) for multipurpose blockchain applications.

The test bed implements a Cyber Grid Guard (CGG) system enhanced with DERs, such as wind farms.

The electrical substation grid test bed was assessed for electrical fault detection, power quality monitoring, DER use cases, and cyber-event tests, implementing a CGG system and DLT.

A DLT framework that relies on a Hyperledger Fabric implementation of a blockchain and uses blockchain-based methods substation electrical grid testbed for verifying device and data trustworthiness on the electric grid. The framework may also rely on another consensus algorithm and implementation of blockchain or DLT.

In an aspect, the employed framework is agnostic to the environment where it is deployed. Such environments can include electrical grid substations or other environments, such as applications with DERs or a microgrid, and can ingest data from the network and secure the data with the blockchain.

In one aspect, there is provided a system for monitoring electrical-energy delivery over an electrical grid. The system comprises: an electrical substation grid-testbed comprising: a simulator operable for simulating power system elements that provision of electrical energy over the electrical grid; and one or more IEDs operably connected with the simulator, the one or more IEDs receiving signals from the simulator and providing responsive measurement data signals over a communications network for storage in an off-chain database; one or more hardware processors associated with the electrical substation grid-testbed for generating a window hash value based on a pre-determined time window of associated electrical-grid measurement data provided by the one or more IEDs and storing the generated window hash value in a ledger of a blockchain data store, the one of the hardware processor devices further communicatively coupled with the off-chain database through the communications network and are further configured to: receive, from the off-chain database, associated electrical-grid measurement data received from the one or more IEDs and detect from the associated electrical-grid measurement data an anomalous event indicating the electrical-grid's ability to deliver electrical energy over the electrical grid; and upon detection of an anomalous event, apply a hash function to the associated electrical-grid measurement data corresponding to the pre-determined time window from the responsive measurement data signals stored in the off-chain database to obtain a further hash value; and compare the obtained further hash value against the generated window hash value stored in the blockchain ledger instance to confirm an integrity of the electrical substation grid-testbed communication with the blockchain data store and off-chain data storage.

In a further aspect, there is provided a method for monitoring electrical-energy delivery over an electrical grid. The method comprises: simulating, using a real time simulator of an electrical substation grid-testbed, power system elements that provision of electrical energy over the electrical grid, the electrical substation grid-testbed having one or more IEDs operably connected with the simulator; receiving, at the one or more IEDs receiving signals from the simulator, and providing responsive measurement data signals over a communications network for storage in an off-chain database; generating, by one or more hardware processors associated with the electrical substation grid-testbed, a window hash value based on a pre-determined time window of associated electrical-grid measurement data provided by the one or more IEDs and storing the generated window hash value in a ledger of a blockchain data store, wherein the one of the hardware processor devices are communicatively coupled with the off-chain database through the communications network: receiving, at the one or more hardware processors, from the off-chain database, associated electrical-grid measurement data received from the one or more IEDs and detecting from the associated electrical-grid measurement data an anomalous event indicating the electrical-grid's ability to deliver electrical energy over the electrical grid; and upon detection of an anomalous event, applying, by the one or more hardware processors, a hash function to the associated electrical-grid measurement data corresponding to the pre-determined time window from the responsive measurement data signals stored in the off-chain database to obtain a further hash value; and comparing, by the one or more hardware processors, the obtained further hash value against the generated window hash value stored in the blockchain ledger instance to confirm an integrity of the electrical substation grid-testbed communication with the blockchain data store and off-chain data storage.

A computer-readable storage medium storing a program of instructions executable by a machine to perform one or more methods described herein also may be provided.

### BRIEF DESCRIPTION OF THE DRAWINGS

Further features as well as the structure and operation of various embodiments are described in detail below with reference to the accompanying drawings. In the drawings, like reference numbers indicate identical or functionally similar elements.

FIG. 1 depicts a “CGG” system which is a DLT-based remote attestation framework that uses blockchain-based methods for verifying device and data trustworthiness on the electric grid according to embodiments herein;

FIG. 2 depicts a one-line diagram of an example electrical substation-grid configuration monitored by the CGG attestation framework of FIG. 1;

FIG. 3 shows the overall electrical substation-grid test bed architecture integrated with elements of the CGG attestation framework of FIG. 1;

FIGS. 4A-4D depict a three-line diagram in a MATLAB/Simulink® model of the electrical substation-grid with customer-owned wind farms corresponding to the one-line diagram of the example substation-grid shown in FIG. 2;

FIG. 5 depicts an overall system architecture and flow diagrams according to embodiments herein;

FIGS. 6A-6B show an event flow diagram depicting the method for running event checks at the example substation-grid test bed when integrated with the CGG system with DLT according to embodiments herein;

FIG. 7 depicts a flow chart depicting a GOOSE data storage module process according to an embodiment herein;

FIG. 8 is a general depiction of a GOOSE dictionary mapping of a dictionary key to GOOSE row tuples according to an embodiment herein;

FIG. 9 is a general depiction of an event check tuples diagram according to an embodiment herein;

FIG. 10A shows an embodiment of an electrical fault boundary computation implemented in the CGG attestation framework according to an embodiment of the present disclosure;

FIG. 10B shows an embodiment of an algorithm flow diagram for evaluating breaker 10-cycle average fundamental as implemented in the CGG attestation framework according to an embodiment herein;

FIGS. 11A-11C show an embodiment of a power quality boundary flow diagram implemented in the CGG attestation framework with FIG. 11A depicting an acceptable power quality voltage measurement boundaries, FIG. 11B depicting an acceptable power quality frequency measurement boundary, and FIG. 11C depicting an acceptable power factor measurement boundary according to embodiments herein;

FIGS. 12A-12C depict using the calculated limits for the voltages, frequency, and total power factor in respective power quality algorithm flow diagrams to show how the power quality normal and non-normal situations are calculated in an embodiment;

FIGS. 13A, 13D, and 13F depict example simulated phase currents for an example electrical fault detection test; FIGS. 13B, 13E, and 13G depict example simulated voltages for the example electrical fault detection test, and FIG. 13C depict a pole state for a particular feeder relay for the example electrical fault detection test;

FIGS. 14A-14C depict respective CGG system A-phase, B-phase and C-phase RMS currents and FIGS. 14D-14F depict respective corresponding CGG system phase voltages of the feeder relay and power meters for the electrical fault detection test;

FIG. 15A depicts a plot showing phase currents and FIG. 15B depicts a plot showing corresponding phase voltages of the feeder relay for the electrical fault detection test;

FIGS. 16A-16C depict respective simulated frequency, phase RMS voltages, and total power factor of the feeder relay for the electrical fault without tripping power quality test, and FIGS. 16D-16H depict plots of CGG system frequency, phase RMS voltages, and total power factor of the feeder relay for the electrical fault without tripping power quality test;

FIG. 17A depicts phase currents and FIG. 17B depicts phase voltages of the feeder relay event for the electrical fault without tripping power quality test;

FIGS. 18A, 18D, 18G and 18I depict plots of simulated phase currents, FIGS. 18B, 18E, 18H and 18J depict plots of simulated voltages, and FIGS. 18C and 18F depict plots of pole states for the feeder grid relay, DER relay and power meters for the respective connection of the grid and wind farm with an example electrical fault test;

FIGS. 19A, 19C, 19E and 19G depict plots of CGG system RMS phase currents and FIGS. 19B, 19D, 19F and 19H depict plots of voltages from the feeder grid relay and DER relay and power meters for the connection of the grid and wind farm with an example electrical fault test;

FIG. 20A depicts a plot of phase currents and FIG. 20B depict a plot of phase voltages for the feeder grid relay event for the connection of the electrical substation with the distribution power line on the grid side with the example electrical fault test;

FIGS. 21A, 21D and 21F depict plots showing simulated phase currents, and FIGS. 21B, 21E and 21G depict plots showing simulated phase voltages, and FIG. 21C depict a plot showing pole states of feeder grid relay and power meters for the combined CT ratio setting change with an example electrical fault test;

FIGS. 22A-22C depict plots of phase RMS currents for the CGG system and FIGS. 22D-22F depict plots of corresponding RMS phase voltages from the feeder grid relay and power meters; and

FIG. 23 conceptually depicts an electrical substation-grid “testbed” 2300 interconnection of components that simulate operations of a control center of FIG. 3 for the CGG attestation framework including the electrical substation-grid test bed.

### DETAILED DESCRIPTION

The present disclosure provide a system and methods (algorithms and codes) for detecting electrical faults and monitoring the power quality for use case scenarios using a novel CGG System with DLT. One implementation describes an electrical substation test bed with a real time simulator and portative relay and power meters in the loop. The CGG system with DLT can secure data from power meters and protective relays of electrical utility substation grids with customer-owned DERs.

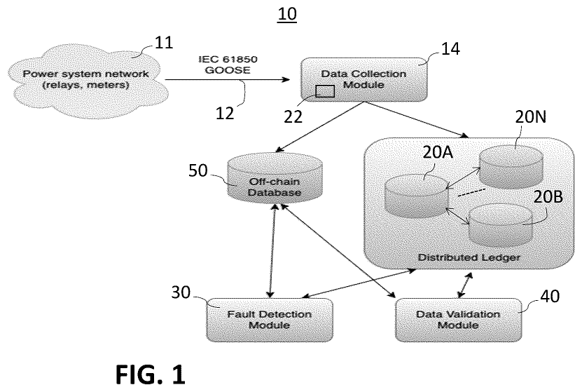

FIG. 1 depicts a processing platform referred to as the CGG system, which is a DLT-based remote attestation framework 10 that uses blockchain-based methods for verifying device and data trustworthiness on the electric grid. In an embodiment, a DLT, implemented using Hyperledger Fabric or another consensus algorithm and approach, is used for achieving device attestation and data integrity within and between grid systems, subsystems, and apparatus including electrical grid devices 11, such as relays and meters on the power grid, in the manner such as described in commonly-owned, co-pending U.S. patent application Ser. No. 18/806,951 entitled DLT Framework For Power Grid Infrastructure, the entire contents and disclosure of which is incorporated by reference as if fully set forth herein.

In one approach, as shown in FIG. 1, DLT-based remote attestation framework 10 runs systems and methods employing an observer or data collection module 14 that captures power grid data 12 and in embodiments, device configuration settings (artifacts) data, to better diagnose and respond to cyber events and/or electrical faults, either malicious or not malicious. The data 12 includes IEDs' commands and values sent over International Electrotechnical Commission (IEC) 61850 standard protocols, including GOOSE (Generic Object-Oriented Substation Events) data according to GOOSE protocol. All IEC 61850 data on the network is captured by using a storage function 22 configured to store IEC 61850 data in an off-chain storage device 50. In an embodiment, a raw packet collection function collects raw packets also for storage in the off-chain data storage device 50. The off-chain data storage device 50 further stores hashes of the raw GOOSE data, e.g., for use in detecting electrical faults and performing attestation checks.

The DLT-based remote attestation framework 10 includes a DLT developed to enable the performance of these functions. The framework includes a set of blockchain computers, referred to as DLT nodes 20A, 20B, . . . , 20N on a network, each node comprising ingesting data for a blockchain, with one DLT node, e.g., DLT node 20A, designated as a master node. In addition, each DLT node can be set at a specific geographical location inside or outside of an electrical substation.

In an embodiment, the DLT nodes 20A, 20B, . . . , 20N store the data from the network and preserve the data immutably and redundantly across the nodes. The data captured include voltage and current as time series data in a raw form as time-sampled alternating current (AC) signals and root mean square (RMS) values. Other data captured include the configuration data of relay and meter devices 11 on the power grid. The nodes communicate with one another to establish a consensus of the data. The DLT nodes 20A, 20B, . . . , 20N can also manage the situation when some of the nodes are compromised by cyber events or malfunction.

As referred to herein, DLT encompasses various technologies that implement data storage in the form of a shared ledger. Ledgers are append-only data structures, where data can be added but not removed. The contents of the ledger are distributed among designated nodes within a DLT network. Consensus mechanisms enable the shared ledger to remain consistent across the network in the face of threats such as malicious actors or system faults. Peer-to-peer communication protocols enable network nodes and participants to update and share ledger data. To provide the necessary functionality to implement a DLT, these components are typically grouped and made available as DLT platforms.

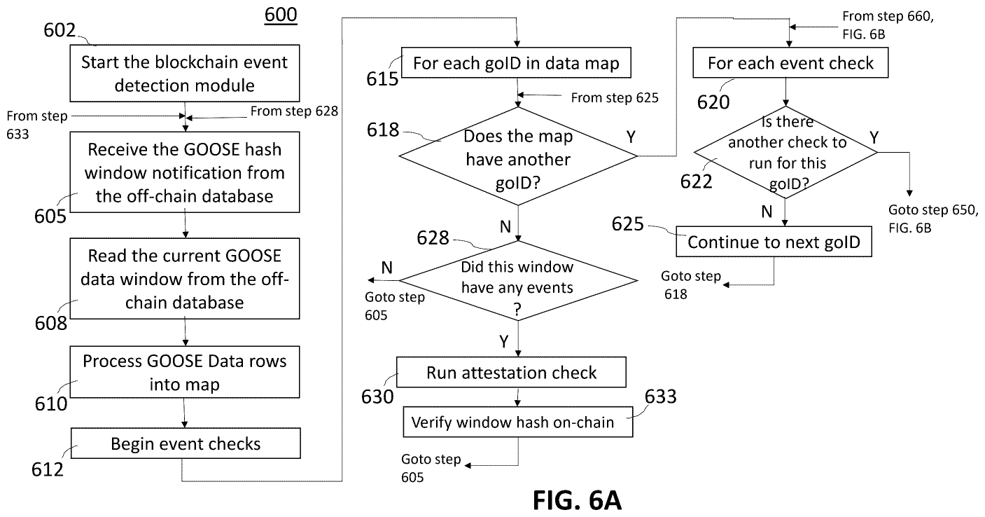

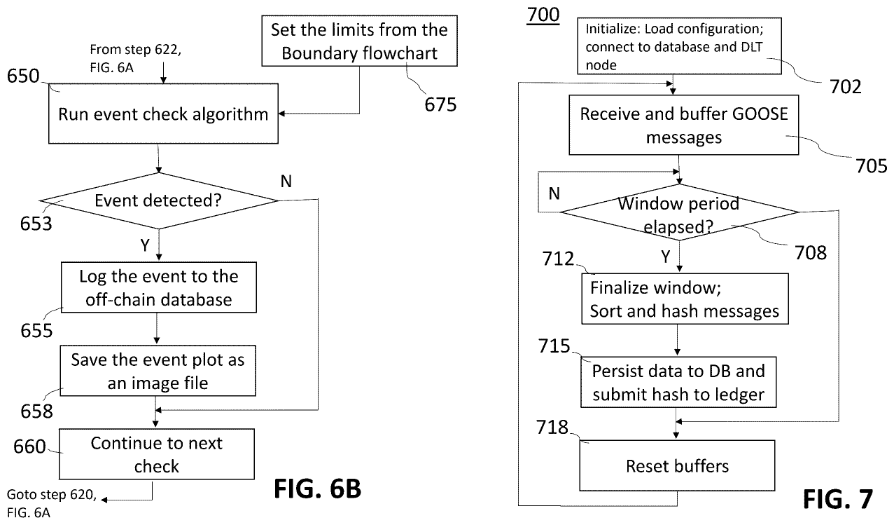

In an embodiment, the DLT-based remote attestation framework 10 further includes a Fault Detection Module 30 connected to off-chain database and one or more of the DLT nodes 20A, 20B, . . . , 20N. The Fault Detection Module 30 uses a dictionary data structure as part of its process to detect electrical faults or anomaly events. It interacts with the off-chain database 50 (where raw GOOSE data is stored) and the distributed ledger (where hashes of the raw GOOSE data are stored, e.g., for use in detecting electrical faults and performing attestation checks). In an embodiment, the fault detection module 30 receives data structures of performed simulation tests from the off-chain database 50 and runs an event flow method (See FIGS. 6A-6B) to detect events and perform attestation checks. Similarly, the DLT-based remote attestation framework 10 (FIG. 1) further includes a Data Validation Module 40 connected to off-chain database and one or more of the DLT nodes 20A, 20B, . . . , 20N. The Data Validation module 40 performs data validation. In an embodiment, by storing hashes of the data in the ledger and storing the data outside of the ledger in off-chain storage database 50, the Data Validation module 40 uses the hashes to validate the integrity of the data, i.e., by checking whether a hash of a window of data stored at the off-chain database is equal to the hash of the window of data that has been stored at the DLT (blockchain) node.

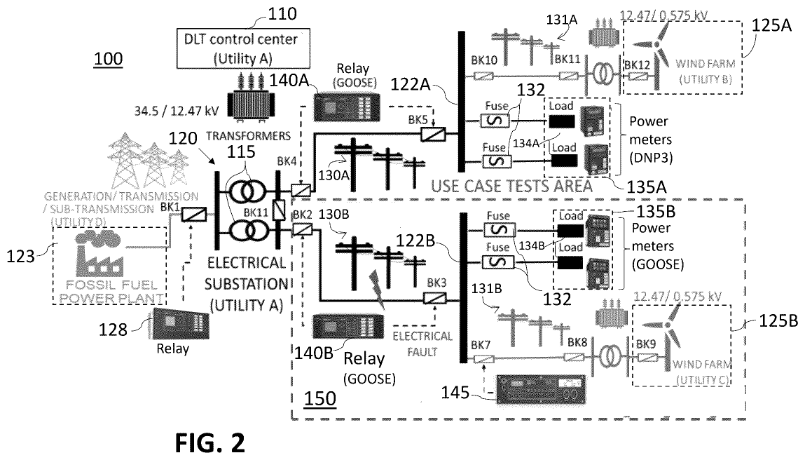

FIG. 2 shows a one-line diagram depiction of a substation test bed 100 with DERs and IEDs managed for controlling and monitoring applications using blockchain-based applications such as in the CGG platform. This test bed 100 uses a software model-simulated power system that can perform electrical faults and cyber-events. In an embodiment, the test bed can be implemented to detect if the blockchain architecture is effective in controlling the utility grid and managing its assets/equipment, e.g. to detect faulted phases at electrical fault, monitor power quality and monitor customer-owned DER use cases. The diagram of FIG. 2, in an example implementation, represents the design of a 34.5/12.47 kV electrical substation 120. The electrical substation 120 was based on a sectionalized bus configuration, with two power transformers 115 and two radial feeders 122A, 122B that were connected to two customer-owned DERs, e.g., wind farms 125A, 125B, as shown in FIG. 2. The power transformers 115 can distribute the electrical power via Utility A's power distribution lines 130A and respective breaker devices labeled BK4, BK5 to radial feeder 122A and likewise, can distribute the electrical power via power distribution lines 130B and respective breaker devices labeled BK2, BK3 to radial feeder 122B. Radial feeder 122A can receive power via Utility B's power distribution lines 131A and breakers labeled BK10-BK12 from connected windfarm 125A for distribution to loads 135A and likewise, radial feeder 122B can receive power via Utility C's power distribution lines 131B and breakers labeled BK7-BK9 from connected windfarm 125B.

As shown in FIG. 2, the Utility A being modeled includes an electrical substation 120 and distribution grid that has a DLT control center 110 that collects data from all power meters and relays. In more detail, utility A's electrical substation 120 has two power transformers 115 of 10 MVA and primary/secondary voltages of 34.5 kV and 12.47 kV, respectively. The electrical grid was a 12.47 kV power system with load feeders 122A, 122B that are connected in a radial configuration; however, the load feeders could be connected to the wind farms 125A, 125B (Utilities B and C). Utilities B and C can be customer owned DERs, e.g., with six 1.5 MW wind turbines (i.e., two 9 MW wind farms). A further Utility D was the main source based on a fossil fuel power plant 123. In a non-limiting example implementation, through the fuses 132, feeder 122A was configured to connect with corresponding load devices 134A and respective power meters 135A, e.g., power meters that, in a non-limiting implementation, can be configured at the Schweitzer Engineering Laboratories (SEL) 734, with the DNP3 protocol, and feeder 122B was configured to connect with corresponding load devices 134B and respective power meters 135B, e.g., power meters that, in a non-limiting implementation can be configured at the Schweitzer Engineering Laboratories (SEL) 735, with the Generic Object-Oriented Substation Event (GOOSE) IEC 61850 protocol. A relay 128, e.g., a SEL 421 relay, at the 34.5 kV side of the electrical substation through a breaker labeled BK1 was configured with the sampled values (IEC 61850) protocol. Further relays 140A, 140B were configured with the GOOSE (IEC 61850) protocol, and a further relay 145, e.g., a SEL 351S relay, was also configured with the GOOSE protocol. These protective relays 128, 140A, 140B, 145 measured the phase voltages and currents; real, reactive, and apparent power; total power factor; frequency; and breaker states that were collected by the DLT-based control center 110 (Utility A). As shown in FIG. 2, simulation tests can be performed on a feeder relay, e.g., relay 122B inside the “use case tests area” 150 to assess the CGG system 10 (FIG. 1) for electrical faults detection, power quality monitoring, DER use cases, and cyber-event tests.

Although not shown, in an embodiment, the protective relays and power meters of the one-line diagram 100 of FIG. 2 are configured in an equipment rack (not shown). These IEDs can be wired to a real-time simulator and communication devices that are connected to a synchronized-time system. In the equipment rack, simulated components of the sub-station model of FIG. 2 include the relays 140A, 140B (e.g., SEL 451 relays); power meters 135A (e.g., SEL 734) and power meters 135B (e.g., SEL 735), relay 128 (e.g., a SEL 421 relay) and further relay 145 (e.g., SEL 351S relay).

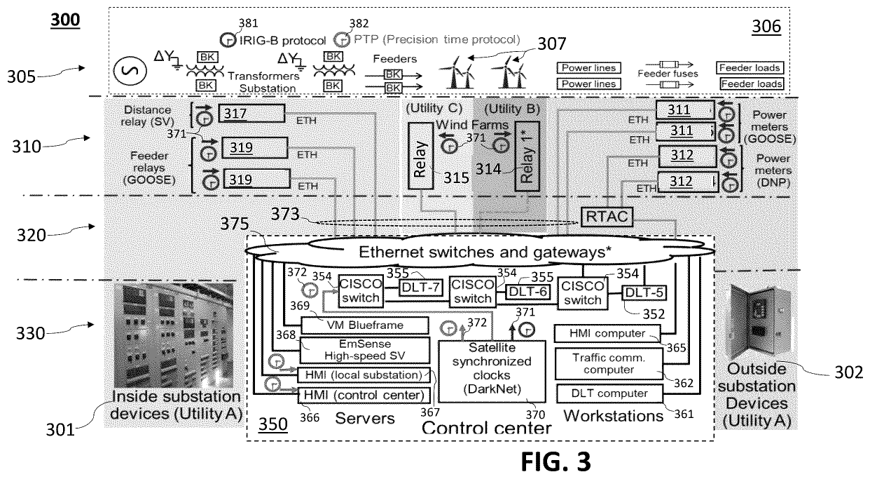

FIG. 3 illustrates an electrical substation-grid test bed architecture 300 implementing the CGG attestation framework of FIG. 1 including the electrical substation-grid with customer-owned DERs (e.g., wind farms 307).

As shown in FIG. 3, the CGG system is used to verify integrity of inside substation devices 301 and outside substation devices 302 of the Utility A electrical substation grid with the customer-owned DERS of FIG. 1. At a physical network level 305, the monitored source devices at the inside substation 301 from which data is collected includes power sources, transformers, electrical substations, breaker devices, feeders, fuses and other power system elements that can be simulated by a real-time simulator 306, while monitored source devices at the outside substation 302 from which data is collected include powerlines, feeder fuses, feeder loads, etc. Additionally shown at physical network level 305 that can be simulated are exemplary DERs such as wind farms 307 (e.g., Utilities B, C). At a next level is a protection and metering network level 310 containing the hardware-in-the-loop (HIL), represented by the physical IEDs such as protective relays and power meters which include, at the outside substation 301, including devices such as both GOOSE protocol-configured power meters 311 and DNP-configured power meters 312, and, at the inside substation 301, devices such as feeder relays 319 and transformer differential devices relay 317 that both provide IEC 61850 GOOSE-protocol (i.e., IEDs in-the-loop). Further connected at the protection and metering network level 310 are further GOOSE-protocol configured feeder relays 314, 315 at each respective DER, e.g., Utility B, Utility C. In an embodiment, real-time simulation tests can be performed with hardware-in-the-loop, e.g., in the manner such as described in commonly-owned, co-pending U.S. patent application Ser. No. 19/065,265 entitled Commissioning Power System testbeds with Hardware-In-The-Loop, the entire contents and disclosure of which is incorporated by reference as if fully set forth herein.

A next automation level includes an automation and access level 320 including the remote terminal units and the ethernet switches including RTU or Real-Time automation controller (RTAC) that connects to an Ethernet-based data communications network 375 of routers, switches and gateways. Wired or wireless communication channels 373 connect the protection and metering devices of protection and metering network level 310 to the Ethernet-based data communications network 375 and Cyber Guard system's distributed ledgers.

A further level of the network hierarchy is a control level 330 consisting of supervisory control and data acquisition, HMI, and synchronized-time system for the CGG system. This level 330 implements a control center 350 within which hardware and software modules and DLT nodes of a CGG attestation framework is configured. In an embodiment, control center 350 within which hardware and software modules and DLT nodes of a CGG attestation framework is configured, includes one node, DLT-5, that is a master node 352 and is used to configure and update the other two DLT nodes 355. It is the DLT-5 node 352 that can be queried when performing attestation checks. In an exemplary embodiment, the control center 350 includes three server machines, e.g., each with processors such as AMD Ryzen 9 3950X 16-core CPUs and 32 GB of RAM to function as DLT nodes, with each node hosting an HLF peer and orderer component.

Generally, the control center 350 of the CGG framework includes computer workstations, servers and other devices that collect packets in the communications network 375 which come from the relays and smart meters and ultimately derived from sensors. These data include voltage and current data for the three phases associated with the relays 317, 319 etc. The data are analog when the devices generate the data but are then converted into digital form. The relays and meter devices package the digital data into packets to be sent over the communications network 375. In an embodiment, attestation framework primarily uses IEC 61850 for the main protocol for SCADA network communications.

In an embodiment, control center 350 consists of a control center human-machine interface (HMI), a local substation HMI, a virtual machine (VM) Blueframe, and EmSense high-speed smart visu (SV) servers/computers in the rack for the CGG system. In an embodiment, computer workstations receiving packet data from the communications network 375 include but is not limited to: a DLT-SCADA computer 361, a traffic network computer 362 and a human-machine interface (HMI) computer 365. Additional server devices of control center 350 receiving packet data include but are not limited to: HMI control center server 366, a local substation HMI server 367, an EmSense server 368, and a BlueFrame asset discovery tool application programming interface (API) 369 for retrieving configurations and settings from the devices as part of the verifier module (VM) functionality.

As shown in the control center configuration 350 of FIG. 3, an additional network clock and timing device 370 for distributing precise timing signals (timing data) via multiple outputs is provided. In an embodiment, synchronized-time protocols used in the architecture implement the precision-time protocol signals 372 and inter-range instrumentation group time code B (IRIG-B) signals 371. The precision-time protocol communication was implemented in the CGG system through the Ethernet network, and the IRIG-B communication was implemented at the power meters and feeder relays. The protective relay 317 transmitted IEC61850-sampled values messages. The protective relays 319 and power meters 311 transmitted IEC61850 GOOSE messages, and the power meters 312 transmitted distributed network protocol (DNP) messages. All these message types are frequently used by electrical utilities at substations.

In an embodiment, network clocking and timing device 370 is a time-synchronized clock that can provide timed signals 371 according to the IRIG-B timing protocol 381 and can serve as a Precision Time Protocol (PTP) grandmaster clock 382 providing the PTP time clock signals 372 to detect faults at an exact time and location. The robustness of using atomic oscillator grand master clocks for the DLT timestamping rather than GPS-based timing ensures the system is protected against GPS spoofing attacks, among other weaknesses related to GPS. Timing is provided by the system clock for the node on which it runs (e.g., master node DLT-5). The system clock is kept in sync using a Linux PTP client running on node DLT-5.

In an embodiment, the control center 350 is configured in a form of a CGG “testbed” that implements several protocols:

One is the IEC 61850 protocol which is a level 2 protocol in which packets are broadcasted over the network. There are several major types of protocols in IEC 61850, including GOOSE values. The GOOSE messages that the CGG relays generate typically contain status information, such as the breaker state for a given relay. Modern relays are considered IEDs, i.e., they are computerized and have networking capability. These relays may also generate other information, including RMS voltage and current. The relays typically send the GOOSE data at lower frequencies than other types of data. Therefore, the time between packets that the relays broadcast is large. The GOOSE messages of relays and power meters are sent to the CGG.

As described, various devices in the CGG test-bed framework, such as relays and smart meters, produce the data as IEC 61850 packets. Relays used in the CGG control center (e.g., testbed) are devices that allow a SCADA system to control breakers and gather sensor readings of voltage and current for all three phases. Modern power systems use AC electricity, which is sinusoidal in nature. The relays receive analog sensor data and sample the sensors at 20 kHz and internally compute RMS values based on the voltage and current. The relays broadcast these values via the network.

### Emsense (Emulated Sensor)

While the EmSense server 368 is a device that emulates a high-resolution sensor for a power grid, it is optional for use or not in this DLT application because IEC 61850 GOOSE data is used and generated by the relays and power meters.

In an implementation, whether configured as a control center 350 in FIG. 3 or in a testbed implementation, the following is assumed:

An asset inventory is first performed for all devices included in the CGG control center 350 (testbed) architecture. Data on, or sent by, a compromised meter or relay device may or may not be affected by an attacker. Data trustworthiness must therefore be established for all source devices. Measurement and status data being sent from the device cannot be trusted unless the configuration artifact data is successfully verified by the verifier by matching its SHA hash to a known good baseline hash. The baseline configuration for devices has not been compromised. Known correct baseline configuration hashes are assumed to be uncompromised.

In an embodiment, the known correct baseline includes an initial configuration of hardware/software/firmware/settings for all devices. Device and network information cannot all be automatically collected for attestation. Some information may have to be collected and entered into the system manually and checked manually. Some data may only be collected by directly connecting to a device or by contacting the vendor. Firmware, software, configurations, settings, and tags are periodically checked against the baseline hashes in the CGG DLT.

The attestation scheme does not include checking updates to device software/firmware before implementation in the applicable component. The native applications that run on the devices have not been compromised or tampered with and therefore provide a trustworthy baseline. The native applications act as the provers responding with attestation evidence (artifacts of configuration data) when the verifier sends the challenge query. The anomaly detection mechanism detects when a native application has been compromised. The mechanism uses the CGG with DLT, which ensures the integrity of the data.

When configured as a CGG testbed implementation, the following specific assumptions are made:

The timing system has an independent backup timing source, e.g., independent from DarkNet and/or the Center for Alternative Synchronization and Timing, that can be switched on when connectivity to this system is down. Timing must remain synchronized for all devices. Data integrity and message authentication are implemented using cryptographic protocols. A hash-based message authentication code is used for message authentication, and SHA256 is used for data integrity. In addition, HLF includes the transport layer security (TLS) protocol for communications security. The anomaly detection framework is configured to detect cyber security attacks, such as man-in-the-middle attacks and message spoofing.

In an embodiment, when configured as a testbed implementation, further prerequisites include:

DLT nodes 352, 355 are located in the substation, metering infrastructure, and control center. As a minimum, three DLT nodes are required to obtain the full benefits of the HLF Raft consensus algorithm where “Raft” is the name attributed to the algorithm's attributes—i.e., reliable, replicated, redundant, and fault-tolerant. Communication paths are required to link the DLT nodes, e.g., via switching components 354.

Asset inventory will be conducted in an automated fashion where possible, with asset discovery tools that leverage vendor asset discovery systems. Integrated methods for asset discovery will be leveraged for IEC 61850. Automated vendor-specific asset discovery tools can be used. While the middleware software can be used to collect baseline data for the meters and relays, other tools and/or developed software may be used. Faults were detected for a subset of the data that was collected.

Assets not identified during the automated asset discovery process must be manually added to the system. Asset discovery and enumeration is required prior to implementation of the CGG remote attestation and anomaly detection framework.

As CGG can be deployed in an operational environment as a control center 350 and can be deployed in a testbed, e.g., to demonstrate the implementation of a DLT. Therefore, some cybersecurity devices that are typically deployed in operational environments may not be included in the testbed configuration, e.g., firewalls and demilitarized zones.

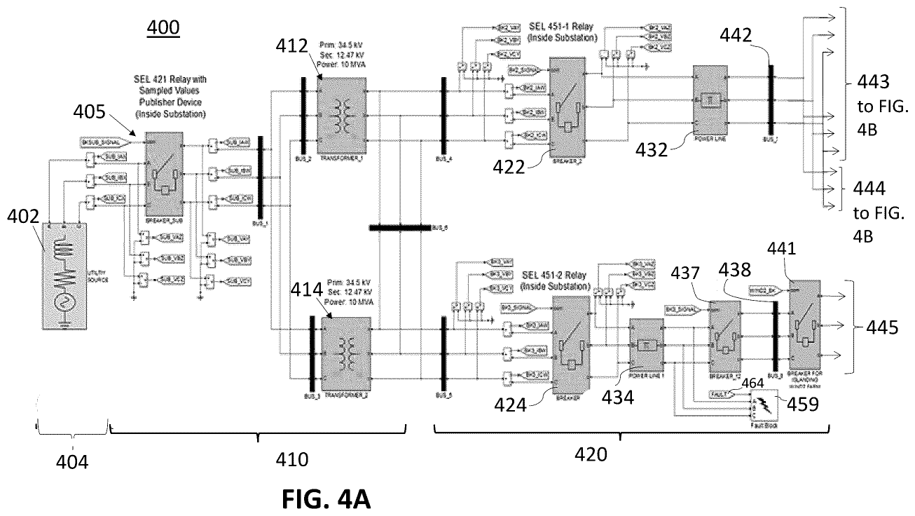

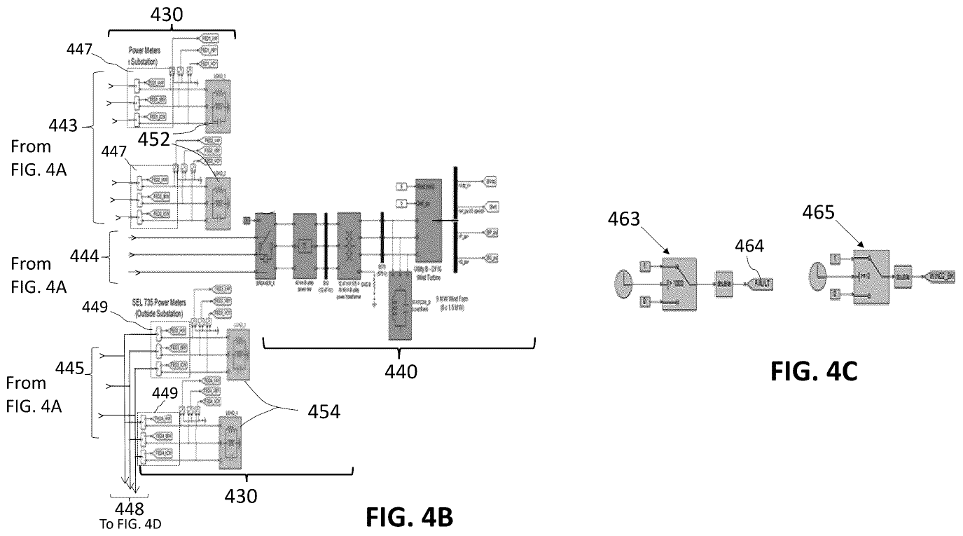

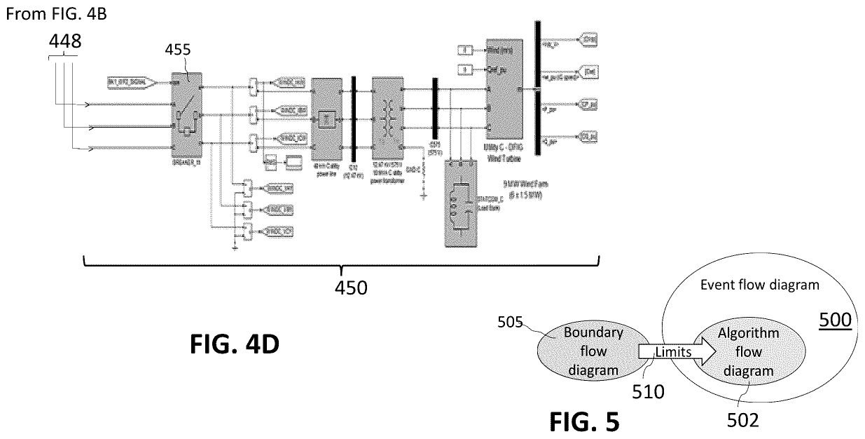

FIGS. 4A-4D depict a three-line diagram 400 in MATLAB/Simulink® model corresponding to the single-line diagram of the electrical substation-grid circuit of FIG. 2 in an embodiment. The three-line diagram was created in an RT-LAB project by using MATLAB/Simulink models to run the tests with the real-time simulator 306 and the IEDs in-the-loop. The electrical substation grid (Utility A) with the customer-owned wind farms (Utilities B and C) is shown in FIGS. 4A-4D.

The electrical substation-grid testbed system 400 shown in FIGS. 4A-4D is implemented using an exemplary sectionalized bus configuration corresponding to the electrical substation-grid testbed power system 100 shown in FIG. 2 including the utility source, electrical substation, power lines, and power load feeders. In FIG. 4A, the electrical substation grid (Utility A) is connected to two DERs (Utilities B and C). Utility D is represented by a fossil fuel power plant generator, transmission, and sub transmission block 404 including utility source power generator 402 that (inside substation) transmission relay 405 of the electrical substation 410. Utility A consisted of electrical substation 410, including transformers 412, 414; and Utility A distribution power lines 420 including inside substation feeder relay breakers 422, 424. Each feeder breaker 422, 424 is connected to a respective distribution power line (12.47 kV) 432, 434 each connected to respective power loads 430 in FIG. 4B. These two 12.47 kV distribution power lines 432, 434 were simulated with a three-phase π (pi) section line block and these pi section line blocks 432, 434 each connect to respective electrical feeder loads 452, 454 as shown in FIG. 4B. In the exemplary Utility A substation representation, as further shown in FIG. 4A, pi section line block 432 connects to an AC bus line 442 providing conductor lines 443 (3-phases) that, as shown in FIG. 4B, connect through respective power meters 447 (e.g., SEL 734) to respective power loads 452. Further, in the exemplary Utility A substation representation, as further shown in FIG. 4A, pi-section line block 434 connects to an AC bus line 438 via a power line breaker 437. AC bus line 437 further connects to an “islanding” breaker 441, and power line breaker 441 provide conductor line outputs 445 that, as shown in FIG. 4B, connect through respective power meters 449 (e.g., SEL 735) to respective power loads 454. As further shown in FIG. 4A, a fault block(s) 459 is configured at or between the power line breakers 424, 437.

As further shown in FIG. 4A, conductor lines 444 also connected to bus 442 as shown in FIG. 4B, connect to substation components of Utility B substation, e.g., an owned DER such as the wind farm 440 (e.g., 12.47 kV). In an embodiment, a steady state of the wind farm is reached at 5-10 seconds. As further shown in FIG. 4B, power lines 445 connect to respective further conductor lines 448 that, as shown in FIG. 4D, connect to substation component of Utility C substation, e.g., a wind farm feeder breaker 455 shown at the owned DER such as the customer-owned wind farm 450 (e.g., 12.47 kV).

Referring to FIG. 4C, there are provided a first switch 463 providing a fault signal 464 that is used to control the fault block 459 of FIG. 4A and a second switch 465 to operate the islanding breaker 441 of FIG. 4A. These switches 463, 465 can be set before running the simulations. Returning to FIG. 4A, the inside substation breaker 405 at the 34.5 kV side is a relay breaker 405 controlled by a transmission relay (e.g., SEL 421) and the substation feeder breakers 422, 424 are controlled by the example SEL 451 relays. Referring back to FIG. 4D, the wind farm feeder breaker 455 is controlled by an example SEL 351S relay. In the load feeders 447, 449, the phase voltages and currents were measured by example power meters (e.g., the SEL 734 and SEL 735 power meters).

In particular FIGS. 4A-4D depict the electrical substation (Utility A), e.g., a 34.5/12.47 kV primary/voltage power system, respectively, and the wind farms, e.g., Utility C 440 and Utility D 450, were on a 0.575/12.47 kV power system. The wind farms had doubly fed induction generator wind turbines. The wind farms of Utilities B and C comprised six 1.5 MW doubly fed induction generator wind turbines each (two wind farms totaling 9 MW each). Utility A is configured as having two 34.5/12.47 kV power transformers 412, 414 of 10 MVA connected in parallel and two feeder breakers 422, 424 of 12.47 kV, e.g., that were controlled by two SEL 451 protective relays in-the-loop. Thus, the phase currents and voltages were collected from the feeder breaker locations. Each feeder breaker was connected to a radial power grid, with two 12.47 kV power lines connected to the feeder loads 452, 454. One power line had two power loads with 50 T fuses, and the other power line had two power loads with 100 T fuses. The phase currents and voltages for the 50 T and 100 T fuses were measured with the power meters 447, 449, respectively, based on the one-line diagram of FIG. 2.

### Electrical Fault Event Detection

The detection of electrical faults at the radial power lines was implemented by finding the boundaries between the minimum root mean square (RMS) current at the electrical faults and the maximum load RMS current. The threshold current to detect the electrical faults conforms to Eq. (1):

$${I}_{RMS MIN FAULT} > {I}_{THR} > 1.3 \times {I}_{RMS MAX LOAD} , \qquad ( 1 )$$

where ITHR is the RMS current threshold measured in amps, IRMS MAX LOAD is the maximum current at normal operation in amps, and IRMS MIN FAULT is the minimum RMS electrical fault current in amps. The load factor contingency is set at 1.3, but it could be configured depending on the load characteristics, e.g., between 1.0 and 1.5.

### Power Quality Event Detection

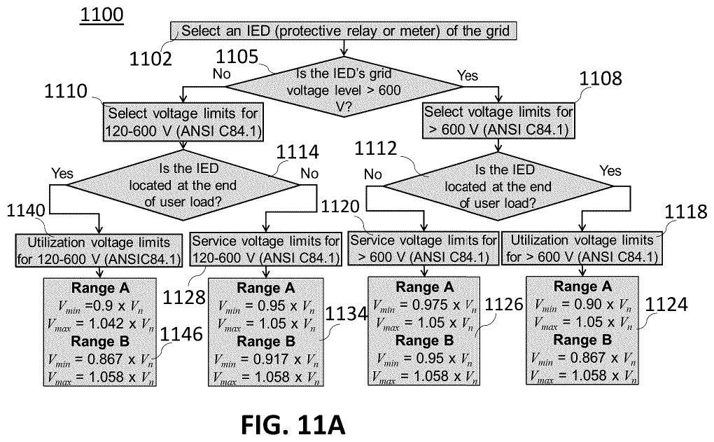

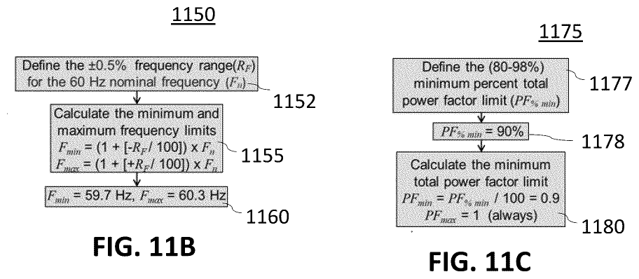

The power quality is based on assessing the voltages, frequency, and total power factor for normal operation in the power grid. The voltage limits were based on the American National Standards Institute (ANSI) C84.1 Standard. Then, the service voltage limits and Range B for the nominal voltage level and user load site location based on ANSI C84.1 Standard were used, and the voltage boundaries to detect the under- and overvoltage situations were calculated using Eq. (2):

$${V}_{N O M} \times 1.0 \; 58 > {V}_{OVER ONE MINUTE} > {V}_{N O M} \times 0 \text{.95} , \qquad ( 2 )$$

where V_{NOM} is the phase to ground nominal RMS voltage of the power grid measured in kilovolts. V_{OVER ONE MINUTE} is the phase to ground RMS voltage in kilovolts measured for more than 1 min to detect the voltage limits during the permanent events instead of transient states (e.g., tripped breakers, electrical faults, switched tap changers). The voltage factor limits between 1.058 and 0.95 are set based on the ANSI C84.1 Standard, that depends on the IED voltage level, IED location and IED application range according to FIG. 11A.

The limits for a 60 Hz electrical grid were calculated by using a range of +0.5%, and the frequency boundaries to detect the under- and overfrequency situations were calculated using Eq. (3):

$${f}_{N O M} \times 1.005 > {f}_{OVER ONE MINUTE} > {f}_{N O M} \times 0.9 \; 95 , \qquad ( 3 )$$

where f_{NOM} is the nominal frequency (60 Hz) measured in hertz, and f_{OVER ONE MINUTE} is the grid frequency in hertz measured for more than 1 min to detect the frequency limits during the permanent events instead of transient states. The frequency factor limits of 1.005 and 0.995 define the 60.3 Hz and 59.7 Hz boundaries to keep a stable frequency in the power grid.

The total power factor can be calculated as the ratio of the total real power to the total apparent power. It could be estimated by using the total real and reactive power using Eq. (4):

$$P F = \frac{P}{\vert S \vert} = \frac{P}{\sqrt{{Q}^{2} + {P}^{2}}} , \qquad ( 4 )$$

where PF is the total power factor measured from 0 to 1, P is the total real power in watts, S is the total apparent power in volt-amperes, and Q is the total reactive power in volt-amperes reactive.

If the total power factor is measured as a percentage, the maximum total power factor is 100%, and the minimum percent total power factor limit is usually between 80% and 98%. If the minimum and maximum power factor are limited between 0.9 (90%) and 1 (100%), respectively, the total power factor boundaries can be estimated by Eq. (5):

$${PF}_{MAX} > {PF}_{OVER ONE MINUTE} > {PF}_{MAX} \times 0.9 , \qquad ( 5 )$$

where PF_{MAX} is the maximum total power factor measured as a percentage (out of 100%), and PF_{OVER ONE INUTE} is the percent total power factor measured for more than 1 min to detect the total power factor limits during the permanent events instead of transient states (e.g., tripped breakers, electrical faults, switched tap changers).

### Inverse Time Overcurrent Curve

Inverse time current (ITC) curves were used to set the relays. Based on the substation feeder breaker relay 422, 424, the inverse time overcurrent setting was based on the U3 Very ITC curves given by the K₁, K₂ and K₃ constants of Eq. (6):

$${T}_{R} = T D S \times ( {K}_{1} + \frac{{K}_{2}}{{M}^{( {K}_{3} )} - 1} ) \times 60 , \qquad ( 6 )$$

where TR is the calculated relay time measured in cycles, TDS is the time dial setting in seconds, M is the applied multiple of pickup current, and K₁ (0.0963), K₂ (3.88), and K₃ (2) are the curve constants for the U3 Very ITC curves. For Eq. (6), the multiple of pickup current (M) is given by Eq. (7):

$$M = \frac{{I}_{S}}{{I}_{P}} = \frac{( \frac{I}{C T R} )}{{I}_{S}} , \qquad ( 7 )$$

where M is the applied multiple of pickup current, I_{S} is the secondary input current measured in amperes, I_{P} is the relay current pickup setting in amperes, I is the primary input current in amperes, and CTR is the current transformer ratio.

By placing Eq. (7) in Eq. (6), the calculated relay time can be estimated by using Eq. (8) or Eq. (9).

$${T}_{R} = T D S \times ( 0.0963 + \frac{3.88}{{( \frac{{I}_{S}}{{I}_{P}} )}^{2} - 1} ) \times 60 , or \qquad ( 8 )$$

$${T}_{R} = T D S \times ( 0.0963 + \frac{3.88}{{( \frac{I / CTR}{{I}_{P}} )}^{2} - 1} ) \times 60. \qquad ( 9 )$$

To estimate the calculated relay time at an electrical fault for an overcurrent relay, Eq. (8) or Eq. (9) could be used. However, although Eq. (8) is based on the secondary input current, Eq. (9) is based on the primary input current and the CTR.

### Use Case Scenarios

The multipurpose electrical substation grid test bed with DLT was used to perform electrical fault detection, power quality monitoring, DER use cases, and cyber-event scenarios. These tests were performed on the feeder inside the use case test area 150 of FIG. 2. Table 1 shows the use case scenarios for the DLT applications at the electrical substation-grid test bed.

TABLE 1

| Tests | Main situation | Test description (total simulation 100 s) |
|---|---|---|
| Fault | LL electrical fault | The electrical fault for phase A and B located at the end of |
| detection* | | the distribution power line was set at 50 s, and the relay |
| | | tripped the breaker. |
| Power | SLG electrical fault | The phase A to ground electrical fault at the end of the |
| quality* | with a nontripped | distribution power line was set at 20 s, and the relay's |
| | breaker | |
| | | breaker did not trip because the trip signal circuit was |
| | | disconnected (breaker failure). |
| DER use | Connection of grid | The power grid (Utility A) was connected with the wind |
| case | (Utility A) and wind | farm (Utility C), and a 3LG electrical fault located at the |
| | farm (Utility C) with | end of the distribution power line was set at 50 s. Then, |
| | a 3LG electrical fault | the relay cleared the electrical fault, and the feeder loads |
| | at the distribution | were fed by the wind farm (Utility C). |
| | power line | |
| Cyber | Combined cyber- | The current transformer ratio setting of the substation |
| events* | event with a SLG | feeder breaker (e.g., SEL 451) relay was changed from 80 |
| | electrical faut | to 1 after 20 s, then a phase A to ground electrical fault |
| | | located at the end of the distribution power line was set at |
| | | 50 s. |

*Tests without DERs (wind farms); SLG: single line to ground, LL: line to line, 3LG: three line to ground.

The electrical fault detection test was based on identifying an overcurrent fault event. The power quality monitoring case test was based on monitoring the frequency, RMS phase voltages, and total power factor. The DER use case test was based on the connection of the power grid (Utility A) and wind farm (Utility C) with a three line to ground (3LG) electrical fault at the distribution power line. The cyber-event test was based on a combined scenario performing a non-desired relay setting with a 3LG electrical fault to determine the relay's behavior and possible effect.

As shown in FIG. 5, the architecture of the CGG system can be based on the event, algorithm, and boundary flow diagrams. The event flow diagram 500 was run in the test bed, and the algorithm flow diagrams 502 were defined for each power system application. As shown in FIG. 5, the boundary flow diagrams 505 calculated the limits 510 of the algorithms, and these were performed externally. FIG. 5 shows the integration of the flow diagrams for the architecture of the CGG system with DLT.

In the CGG system, the DLT was used in the implementation of the monitoring systems. The DLT is a platform that uses ledgers stored on separate, connected devices in a network to ensure data accuracy and security. The three features of the DLT are the distributed nature of the ledger, the consensus mechanism, and cryptographic mechanisms. As shown in FIGS. 6A-6B, based on this platform, the event flow method 600 for the event detection module was implemented in a Python module “powersys_event_detect.py” of the CGG framework.

FIG. 7 shows the GOOSE data storage module process 700 that continually runs in the CGG system to continuously collect GOOSE packets from the network, e.g., received from the breaker relays and power meters, and store and organize them in windows of a predetermined duration, e.g., 60 seconds. As shown in FIG. 7, at 702, the method initializes the module by loading configuration settings and establishes connections to both the off-chain database and DLT node. Step 705, FIG. 7 represents the step of the GOOSE data storage module receiving and buffering in memory storage buffers raw GOOSE-protocol data messages, e.g., simulation data measurements received from the electrical substation grid test-bed hardware-in-the-loop such as the feeder breaker relays, power meters. Then, at 708, a determination is made as to whether a “window” period of time for collecting GOOSE data messages has elapsed. In embodiments, the GOOSE data storage module remains on-line continually receiving data messages for storage at the off-chain database over a configurable time period or “window”. In this embodiment, the window can be 60 seconds (1 minute) of received GOOSE data messages. After the Window time period has elapsed at 708, the process proceeds to 712 where the window is finalized. At 712, the recent collected GOOSE data messages (a window of time's worth of messages) are sorted according to their individual identifiers, referred to herein as “goID”, and a mathematical hash of the windows worth of messages is generated for storage in the ledger. At this step, finalizing a window in the storage module entails completing a batch of the buffered GOOSE packets for the current window. In an embodiment, the packets (which are buffered in memory as JSON strings) in the window are sorted. This is necessary to ensure deterministic ordering for the hashing process. Attestation involves re-computing this hash, so if the storage module and the attestation module did not use the same order they could compute different hashes for the same data. In an example implementation, a SHA256 hash is computed over the sorted packets. This produces the window hash that uniquely identifies this batch of GOOSE packets. Then, at 715, FIG. 7, this sorted packet data and the computed hash are inserted into (i.e., persisted to) the off-chain database. Further, at 715, there is generated a Window notification message that may be sent to an event detection module for receipt in the event flow process to check for the instance of any events associated with the devices sending messages in that pre-determined time window based on the collected raw data. Further, the generated mathematical hash of the Window's worth of sorted GOOSE data messages is appended to the ledger of the DLT used with the CGG system. Finally, at 718, the memory storage buffers for storing the windows of GOOSE data message are reset and the process returns to 705, FIG. 7 to continually receive and buffer further GOOSE data packets.

In view of FIG. 6A, event flow diagram 600 includes at 602 the initial starting of the blockchain event detection module. This entail the performing of steps such as: loading environment variables (e.g., plot directory, DB credentials); establishing a persistent connection to the off-chain database; and subscribing to notifications for new rows in a GOOSE hash window table on that connection, in particular, by subscribing to notifications from the off-chain database about new windows of IEC 61850 GOOSE packets that were collected from the network and then stored. Then at 605, the event detection module receives a GOOSE hash window notification from the off-chain database. This notification can include a JavaScript Object Notation (JSON)-formatted data structure. Each window has a corresponding SHA256 hash, which is stored in the Hyperledger Fabric DLT to provide trust-anchoring of the GOOSE data. Then at 608, FIG. 6A, event detection module uses the “psycopg2” library to read the current GOOSE data window from the off-chain database and standard Python libraries to structure and check (read) the windows of GOOSE packet data for events. To read the current GOOSE data window at 608, FIG. 6A, the event detection module functions to query the window of GOOSE data from the off-chain database using the timestamps from the previous step. First, the rows of data queried from the database are transformed into a dictionary. Each row of data represents a GOOSE packet and includes the goID: GOOSE device identifier (ID), time stamp, and data set values. This results in a list of tuples: (goid, timestamp, . . . all device data fields . . . ), e.g., where a device can be a relay or meter. Table 2 describes an example of specific data set values used for checking events.

TABLE 2
GOOSE data set fields used in event checks

| Field name | Value (unit) |
|---|---|
| magVoltagePhaseA | 10-cycle average fundamental phase A voltage magnitude (V) |
| magVoltagePhaseB | 10-cycle average fundamental phase B voltage magnitude (V) |
| magVoltagePhaseC | 10-cycle average fundamental phase C voltage magnitude (V) |
| magCurrentPhaseA | 10-cycle average fundamental phase A current magnitude (A) |
| magCurrentPhaseB | 10-cycle average fundamental phase B current magnitude (A) |
| magCurrentPhaseC | 10-cycle average fundamental phase C current magnitude (A) |
| magFreqHz | Measured system frequency (Hz) |
| magTotW | Fundamental real three-phase power (W) |
| magTotVAr | Fundamental reactive three-phase power (VAR) |

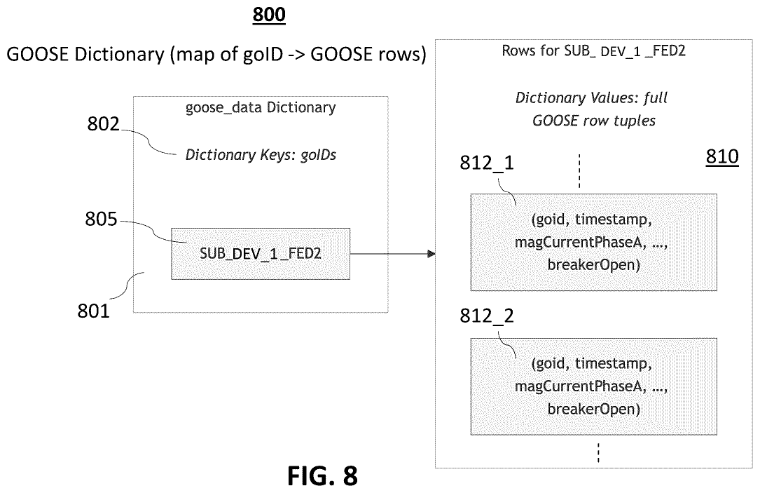

Continuing to 610, FIG. 6A, the event detection module processes the GOOSE rows into a map using the goIDs as keys. The dictionary maps each goID to its list of rows in the current window, i.e., a dictionary process groups each rows so that a goID (key) maps to a list of GOOSE rows (value). The GOOSE data set fields can vary by goID. For example, in the electrical substation test bed, the devices such as relays and power meters have different GOOSE data sets. FIG. 8 shows an example Goose Dictionary mapping 800 of a goID to GOOSE rows. The “map” and “dictionary” both refer to a data structure that stores key-value pairs. To “map” means to establish this key-value relationship in the dictionary data structure 801. In this case, the keys 802 are the goIDs (the device ID field of GOOSE messages) and the values 810 are a list of all the GOOSE message data for that goID for that window. This keeps the data organized by goID so it can be checked for the event conditions. In an example mapping shown in FIG. 8, a GOOSE data Dictionary data structure 801 includes Dictionary Keys: goIDs 802. An example goID key 805 relates to the substation feeder relay breaker, e.g., 424, FIG. 4A, which can be controlled by a SEL 451 relay implementation. This goID key 805 maps to a list of dictionary values 810 which contain full GOOSE row tuples for that goID, e.g., tuple rows 812_1, 812_2, etc.

Returning to 612, FIG. 6A, the event detection module starts the event checks process for the relevant goID data in the current window. The event check process decouples the varying check data into tuples that each contain the check label, a function to perform the check on the relevant GOOSE data set values, the check description/details string, and the event duration threshold. These are then used in a higher-level event check function to perform the checks. This allows generic event detection functions to iterate over checks without hardcoding the specifics of each check.

The event checks are defined as tuples within a list with each tuple containing the check label, a function to perform the check on the relevant GOOSE data set values, the check description/details string, and the event duration threshold. At 612, the event detection module can first initialize an empty “confirmed_events” list. Then, the method enters a nested-loop structure to process every goID and every check. The nested-loop structure involves an outer-loop beginning at 615, FIG. 6A, where, for each goID in the data map: the method skips any goID with zero rows, and at 618, makes a determination whether the map has a/another goID. If it is determined that the map includes a/another goID at 618, there is entered an inner-loop at 620, FIG. 6A, where, for each event check, the module has a predefined list of checks (e.g., over-voltage, under-frequency, low power factor (PF), etc.).

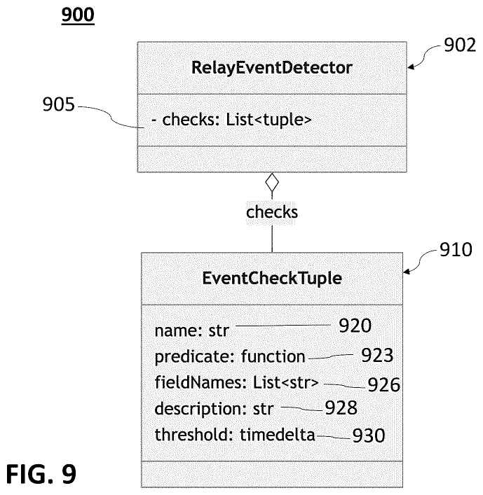

FIG. 9 shows an event check tuples diagram 900 including an event detection object class 902 which has a list of event check tuples in the form of a “checks” variable 905 with the structure and data types of the event check tuples 910 in this list. As shown in FIG. 9, each event check tuple 910 includes the following: 1. A name: <str> field 920 where “str” indicates a string data type and “List<str>” indicates a list of strings; 2. A predicate: function field 923; 3. A field(s) of the corresponding GOOSE data to test including a fieldNames: List <str> 926; 4. An event description: <str> field 928; and 5. A duration threshold: timedelta field 930. An example event check tuple (for an over-voltage in phase A check) is as follows:

```
(
  “over_voltage_phaseA”,
  is_over_voltage,
  [“magVoltagePhaseA”],
  “over-voltage for magVoltagePhaseA”,
  timedelta(seconds=min_duration),
)
```

In this example event check tuple (e.g., for the over-voltage in phase A check), the <str> 920 is “over_voltage_phaseA” which represents the name of the check (used in logging event details and persisting them in the off-chain database); The “is_over voltage” is the predicate function name for this example “over_voltage_phaseA” event check. The [“mag VoltagePhaseA”] is a (single) example of a GOOSE field name used in this check. The “over-voltage for mag VoltagePhaseA” is an event description for this example; and the timedelta (seconds=min_duration) specifies the event duration threshold (e.g., min_duration is 60 seconds) which is the length of a GOOSE window.

Returning to event flow method 600 of FIG. 6A, at 622, a determination is made as to whether there is another check to run for the current goID. If, at 622, it is determined that there is no other check to run for this goID, i.e., the module has processed all checks for this goiID, the method at 625 returns to the outer loop processing by returning to 618, FIG. 6A and process the next goID. Otherwise, at 622, if it is determined that there is another check to run for this goID, the method continues to 650, FIG. 6B to run the event check algorithm, e.g., electrical fault detection algorithm, power quality algorithm. In an embodiment, for the implementation of the event check algorithm at 650, the electrical fault and power quality boundary limits can be set by running an electrical fault boundary method and/or a power quality boundary method as shown at 675, FIG. 6B are set according to the power system application within the event flow diagram. In an embodiment, with respect to setting boundary limits, the numeric threshold(s) for the check are pre-configured before the module runs. These threshold(s) are used to know what values count as an “event.” The event check iterates over every timestamped GOOSE row for this goID and performs: extracting the relevant field(s) from the row; calling the predicate on those values; feeding the boolean result plus the timestamp into a function which maintains “event active” vs. “event start” state and only flagging an event when a duration criterion is met. For example, the event duration threshold interval is used to filter out events that do not meet the minimum duration, e.g., using a default duration of 60 sec.

Continuing to step 653, FIG. 6B, based on a result of running the appropriate event check algorithm at 650, a determination is made as to whether an event is detected. If an event is detected, the process proceeds to log the event to the off-chain database. In an embodiment, as part of the event check algorithm, a check function returns a Boolean value representing whether the GOOSE value(s) given as argument(s) represent an event (e.g., using true) or not (e.g., using false). For example, a particular check function (e.g., electrical fault detection algorithm) might check whether values of the phase current magnitude fields are greater than a current magnitude threshold value (e.g., 200 A) based on Eq. (1), resulting in a true event for that value and returning the result. In an embodiment, the event state is maintained for each goID and the event check determines when events start and stop. For example, the module can build an EventDetails (start, end, goid, check_name, details) data object, append it to a “confirmed_events” data structure and, at 655, FIG. 6B, log the message containing these event details. Further, at 658, FIG. 6B, the module may call an event plotting function to generate a plot and save it, e.g., as a PNG image file. In an embodiment, the valid events are logged and inserted into the off-chain database and can be saved automatically as event plot image files using the Pandas, Matplotlib, and Seaborn opensource programs/libraries. This logging is handled by a separate event plotter class that maintains custom plot settings per event check, such as y-limits and threshold annotations. These plots can be used to quickly analyze detected events using visual inspection. Finally, valid events trigger an attestation check of GOOSE data by comparing hashes of the current off-chain GOOSE data with those in the ledger. Continuing to 660, FIG. 6B, after saving the event plot as an image filed, the process returns to step 620, FIG. 6A for further processing of event checks for the current goID and the event check process started at 650 repeats. Otherwise, returning to 653, FIG. 6B, based on a result of running the appropriate event check algorithm at 650, if it is determined that no event is detected, the process proceeds directly to 660 to continue to the next check by returning to step 620, FIG. 6A and the event check process repeats for that goID. Thus, whether an event is logged or not, the method proceeds immediately to the next check in the list (i.e., inner loop event check).

Otherwise, returning to 618, FIG. 6A, if it is determined that the map does not have another goID, then the process proceeds to 628 where a determination is made as to whether within the current window any events were detected. If there were no events detected at 628, then the process returns back to 605, FIG. 6A, where the system waits to receive the next GOOSE hash window notification in which case, the entire process is repeated for each new time window. Otherwise, if at 628, it is determined that events were detected in this window, the process continues at 630 to run an attestation check. In particular, at 630, FIG. 6A, the DLT CGG facilitates data and device attestation by storing hashes of the data in the ledger and storing the data outside of the ledger in the off-chain storage database 50 (FIG. 1). For example, in an embodiment, in view of FIG. 7, step 712, a corresponding “Window” hash can be generated based on the raw device data collected from IED devices for a predetermined time window (e.g., one minute) and each successive time window(s) that is appended to the blockchain ledger instance in each DLT node. For attestation, a hash can be generated based on the raw data stored at the off-chain database for the same time window and compared to the Window hash in order to prove the integrity of the data collected. For example, the same hashing algorithm can be applied to the window's worth of data stored in the off-chain database based on the stored time stamped messages and a comparison is made at 633, FIG. 6A, to ensure that the hash of the data stored in the off-chain database matches the Window hash for the same predetermined time window that is stored in the ledger. The hashes are used to validate the integrity of the data. Because the CGG system with DLT can be implemented in a distributed environment, remote attestation is necessary. Remote attestation includes a data validation module 40 (FIG. 1) that validates data. In an embodiment, because many of the devices in the electric grid have limited processing and storage capacity, CGG implements software-based remote attestation.

In an embodiment, the attestation check task at 630 is initiated once. This enqueues a single attestation job that will compare the off-chain hash just processed against the on-chain record appended to the DLT blockchain. The module logs that attestation task was scheduled. Then, the process proceeds to 633, FIG. 6A where the module verifies the window hash on-chain. The verification process is handled by an attestation worker process, e.g., in another processing loop. That background process fetches the stored chaincode hash, compares it against the off-chain window hash, then logs or alerts on any mismatch.

### Electrical Fault Boundary and Algorithm Flow Diagrams

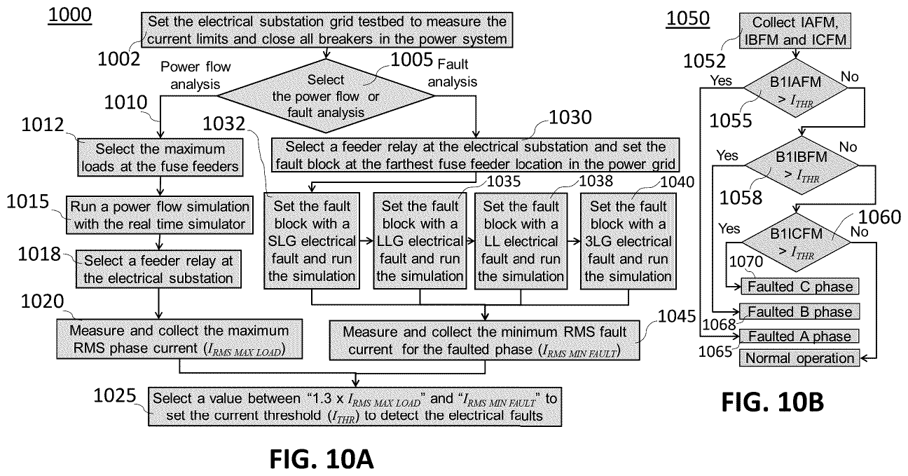

FIG. 10A shows an electrical fault boundary algorithm 1000 performed to detect the electrical faults at the power system implemented in the electrical substation-grid test bed. Initially, the electrical fault boundary algorithm 1000 involves at 1002, setting the electrical substation grid testbed to measure the current limits and close all breakers in the power system. Once substation grid testbed is set for measuring, the process proceeds to 1005 to prompt selection of a power flow procedure or fault analysis procedure. Following the power flow analysis path 1010, the process proceeds to 1012 in order to select the maximum loads at the fuse feeders. Then, at 1015, there is run at the substation grid testbed a power flow simulation with the real time simulator. Then, after running a power flow simulation, the process continues to 1018 to select a feeder relay at the electrical substation. Then the process proceeds to 1020 where the substation grid testbed measures and collects the maximum RMS phase current (I_{RMS MAX LOAD}). Continuing from 1020, FIG. 10A, a final step 1025 involves selecting of a current threshold value (I_{THR}) as a value between “1.3×I_{RMS MAX LOAD}” and “I_{RMS MIN FAULT}”. Returning to 1005, if a fault analysis procedure is selected, the process proceeds to 1030 where a selection is made of a feeder relay at the electrical substation and setting of the fault block at the farthest fuse feeder location in the power grid. After selecting the feeder relay and setting the fault block, the process proceeds to perform the following steps: setting the fault block with an SLG electrical fault and running the simulation at 1032; setting the fault block with an LLG electrical fault and running the simulation at 1035; setting the fault block with an LL electrical fault and running the simulation at 1038; and setting the fault block with an 3LG electrical fault and running the simulation at 1040. After setting the faults and performing the simulations, the process proceeds to 1045, FIG. 10A, where at the grid testbed, the method performs measuring and collecting the minimum RMS fault current for the faulted phase (I_{RMS MIN FAULT}). Finally, the process performs the final step 1025 of selecting a current threshold value (I_{THR}) as a value between “1.3×I_{RMS MAX LOAD}” and “I_{RMS MIN FAULT}”.

Thus, the electrical fault boundary algorithm is based on the following: (1) finding the range between the minimum RMS fault current and maximum load RMS current to detect the overcurrent electrical faults; implementing electrical fault simulations by (2) setting the single line to ground (SLG), line to line ground (LLG), line to line (LL), and three line to ground (3LG) electrical faults in the test bed to measure all electrical fault RMS currents; and implementing power flow simulations (3) finding the minimum electrical fault RMS current, at the electrical substation-grid test bed to detect the maximum load RMS current; (4) setting the threshold values for the maximum and minimum currents with a value between the 1.3×I_{RMS MAX LOAD} (the maximum load RMS current) and the I_{RMS MIN FAULT} (the minimum electrical fault RMS current); and (5) calculating the RMS current threshold (I_{THR}) to set the algorithm and detect the faulted phases at the electrical substation feeder relay.

The electrical fault algorithm is now described with respect to FIG. 10B. The algorithm flow diagram 1050 of FIG. 10B begins at 1052 with collecting the IAFM, IBFM and ICFM (i.e., breaker 10-cycle average fundamental) for each of the three current phases I_{A}, I_{B} and I_{C} of the inside substation feeder relay breaker 424 of FIG. 4A. Continuing, a determination is made as to whether the breaker 10-cycle average fundamental B1IAFM calculated at the relay is greater than I_{THR}, i.e., whether B1IAFM>I_{THR}. If it is determined at 1055 that the breaker 10-cycle average fundamental B1IAFM>I_{THR}, then the process returns a Faulted A phase at 1065. Otherwise, if it is determined at 1055 that the breaker 10-cycle average fundamental B1IAFM is not greater than I_{THR}, then the process proceeds to 1058 where a determination is made as to whether the breaker 10-cycle average fundamental B1IBFM calculated at the relay is greater than I_{THR}, i.e., whether B1IBFM>I_{THR}. If it is determined at 1058 that the breaker 10-cycle average fundamental B1IBFM>I_{THR}, then the process returns a Faulted B phase at 1068. Otherwise, if it is determined at 1058 that B1IBFM is not greater than I_{THR}, then the process proceeds to 1060 where a determination is made as to whether the breaker 10-cycle average fundamental B1ICFM calculated at the relay is greater than I_{THR}, i.e., whether BIICFM>I_{THR}. If it is determined at 1060 that the breaker 10-cycle average fundamental B1ICFM>I_{THR}, then the process returns a faulted C phase at 1070. Otherwise, if none of these phase current magnitude measurements exceed I_{THR}, then the phase currents are in normal operation.

Based on the electrical substation-grid test bed, the feeder relay breaker 424 (e.g., SEL 451) of FIG. 4A located at the electrical substation had a maximum load current between 70 and 140 A, and the minimum electrical fault current was 1051 A (SLG electrical fault). Thus, in the example use case, from FIG. 10A, the selected RMS current threshold was 200 A to set the algorithm for detecting the overcurrent electrical fault events.

CGG system's pseudo code 1. Electrical faulted phase anomaly detection code:

```
. . .def detect_electrical_faults(self, goose_data: dict) -> List[EventDetails]:
  “““Returns the first faulted phase event for each phase in the current window for each
goID.”””
  current_threshold_a = 200.0
  events = [ ]
  for goid in self._relay_goids:
    # skip if no window data for goid
    if goid not in goose_data or (
      goid in goose_data and len(goose_data[goid]) == 0
    ):
      continue
    phase_a_start = None
    phase_b_start = None
    phase_c_start = None
    for row in goose_data[goid]:
      if not phase_a_start and row[self._relay_field_name_to_index(“magCurrentPhaseA”)]
> current_threshold_a:
        phase_a_start = row[1]
      if not phase_b_start and row[self._relay_field_name_to_index(“magCurrentPhaseB”)]
> current_threshold_a:
        phase_b_start = row[1]
      if not phase_c_start and row[self._relay_field_name_to_index(“magCurrentPhaseC”)]
> current_threshold_a:
        phase_c_start = row[1]
      if all([phase_a_start, phase_b_start, phase_c_start]):
        break
    if phase_a_start:
      events. Append(EventDetails(phase_a_start, phase_a_start, goid,
“electrical_fault_phaseA”, f“Electrical fault detected in window for phase A starting at
(phase_a_start}”))
    if phase_b_start:
      events.append(EventDetails(phase_b_start, phase_b_start, goid,
“electrical_fault_phaseB”, f“Electrical fault detected in window for phase B starting at
{phase_b_start}”))
    if phase_c_start:
      events.append(EventDetails(phase_c_start, phase_c_start, goid,
“electrical_fault_phaseC”, f“Electrical fault detected in window for phase C starting at
(phase_c_start}”))
  return events . . .
```

### Power Quality Boundary and Algorithm Flow Diagrams

In the power quality application, the boundary flow diagram defines the limits for the algorithm flow diagram. FIGS. 11A-11C depict the boundary flow diagrams for the power quality algorithm.

FIG. 11A depicts a boundary flow diagram 1100 for calculating the voltage limits; FIG. 11B depicts a boundary flow diagram 1150 for calculating the frequency limits, and FIG. 11C depicts a boundary flow diagram 1175 for calculating the power factor limits.

As shown in FIG. 11A, boundary flow diagram 1100 for calculating the voltage limits begins at 1102 where a processor receives a selection of the IED (i.e., protective relay or power meter) of the substation grid. Next at 1105, a determination is made as to whether the selected IED's grid voltage level is greater than a threshold voltage, e.g., whether grid voltage level >600 V. If the selected IED's grid voltage level is greater than 600 V, then the process continues to 1108 where the voltage limits is selected for >600 V (according to the ANSI standard C84. 1). Otherwise, if the selected IED's grid voltage level is not greater than 600 V, then the process continues to 1110 where the voltage limits is selected for between 120 V-600 V (according to the ANSI standard C84. 1).

The voltage limits (FIG. 11A) were calculated based on the ANSI C84.1 Standard. The voltage limits depend on the nominal voltage level and the non- or user-load site location of the selected IED. After selecting the voltage limits at either 1108 or 1110, the process proceeds directly to either respective steps 1112 or 1114 where a determination is made as to whether the IED is located at the end of the user load. If at 1112, it is determined that the IED is located at the end of the user load, then the process proceeds to 1118 to set the utilization voltage limits for >600 V. Then, the process continues at 1124, where for an optimal voltage range, the utilization voltage limits are set as follows: Vₘᵢₙ=0.90× Vₙ, where Vₘᵢₙ is the minimum voltage limit and Vₙ is the nominal voltage at the IED's location, and Vₘₐₓ=1.05×Vₙ, where Vₘₐₓ is the maximum voltage limit; and alternatively, at 1124, for an acceptable (but not optimal) range, there is set utilization voltage limits as follows: Vₘᵢₙ=0.867× Vₙ and Vₘₐₓ=1.058× Vₙ. Otherwise, returning to 1112, if it is determined that the IED is not located at the end of the user load, then the process proceeds to 1120 to set the service voltage limits for >600 V. Then, the process continues at 1126, where for an optimal voltage range, the service voltage limits are set as follows: Vₘᵢₙ=0.975×Vₙ and Vₘₐₓ=1.05×Vₙ; and alternatively, at 1126, for an acceptable (but not optimal) range, the service voltage limits are set as follows: Vₘᵢₙ=0.95× Vₙ and Vₘₐₓ=1.058× Vₙ.

Returning to 1114, FIG. 11A, if it is determined that the selected IED is not located at the end of the user load, then the process proceeds to 1128 to set the service voltage limits for between 120-600 V (according to the ANSI C84.1 standard). Then, the process continues at 1134, where for an optimal voltage range, the service voltage limits are set as follows: Vₘᵢₙ=0.95×Vₙ and Vₘₐₓ=1.05× Vₙ; and alternatively, at 1134, for an acceptable (but not optimal) range, there is set service voltage limits as follows: Vₘᵢₙ=0.917× Vₙ and Vₘₐₓ=1.058×Vₙ. Otherwise, returning to 1114, if it is determined that the IED is located at the end of the user load, then the process proceeds to 1140 where the utilization voltage limits are set between 120-600 V. Then, the process continues at 1146, where for an optimal voltage range, the utilization voltage limits are set as follows: Vₘᵢₙ=0.9×Vₙ and Vₘₐₓ=1.042× Vₙ; and alternatively, at 1146, for an acceptable (but not optimal) range, the utilization voltage limits are set as follows: Vₘᵢₙ=0.867×Vₙ and Vₘₐₓ=1.058× Vₙ.

As shown in FIG. 11B, the boundary flow diagram 1150 for calculating the frequency limits begins at 1152 where there is defined a +/−0.5% frequency range (R_{f}) for the 60 Hz nominal frequency (Fₙ). Next at 1155, the processor calculates the minimum and maximum frequency limits where:

$${F}_{min} = ( 1 + [ - {R}_{f} / 100 ] ) \times {F}_{n} , and$$

$${F}_{max} = ( 1 + [ + {R}_{f} / 100 ] ) \times {F}_{n} , and$$

where Fₘᵢₙ is the minimum frequency limit, Fₘₐₓ is the maximum frequency limit and Fₙ is the nominal frequency. Continuing to 1160, FIG. 11B, the minimum frequency limit Fₘᵢₙ=59.7 and the maximum frequency limit Fₘₐₓ=60.3. In embodiments, the frequency range is usually within +/−0.5% for a 60 Hz grid.

As shown in FIG. 11C, the boundary flow diagram 1175 for calculating the power factor limits begins at 1177 where there is defined an 80%-98% minimum percent total power factor limit (PF_{% min}). Next at 1178, the minimum percent total power factor limit is set at 90%, i.e., PF_{% min}=90%. Then, at 1180, the processor calculates the minimum total power factor limit (PFₘᵢₙ) according to:

PFₘᵢₙ=PF_{% min}/100=0.9. The power factor maximum limit is always 1, i.e., PFₘₐₓ=1.

In an example use case, an IED was a feeder relay (e.g., SEL 451 relay) that was not located on a user load site. Then, the Range B of the ANSI C84.1 service voltage limits was selected. The voltage was set between 95% and 105.8% for the minimum and maximum voltage limits, respectively. The limits for the under- and overvoltage were 6.84 and 7.62 kV, respectively. For a 60 Hz electrical grid, the frequency limits (FIG. 11B) were calculated by using a range of +0.5%, obtaining a minimum and maximum frequency of 59.7 and 60.3 Hz, respectively. For the total power factor measured as a percentage, the maximum percent total power factor was 100%, and the minimum percent total power factor limit was usually between 80% and 98%. Then, the selected minimum and maximum power factors were 0.9 (90%) and 1 (100%), respectively (FIG. 11C).

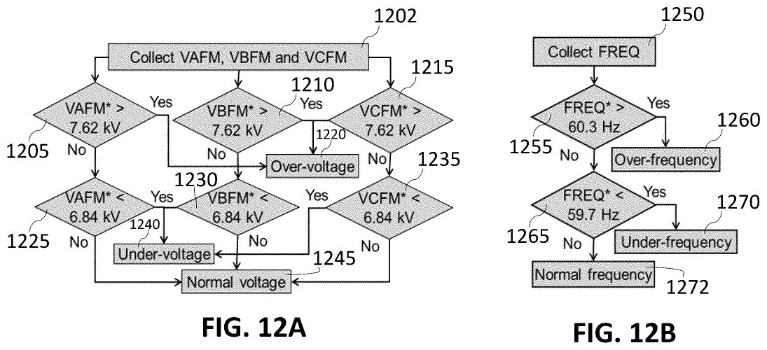

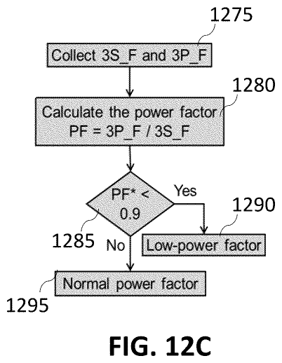

FIGS. 12A-12C depict the power quality algorithms according to an embodiment herein. In an embodiment, in FIG. 12A, the substation feeder relay 140B (e.g., a SEL-451) in use case test area 150 of FIG. 2 was used to measure and calculate, at 1202, the 10-cycle average fundamental A (VAFM), B (VBFM) and C (VCFM) phase voltage magnitudes; in FIG. 12B, the substation feeder relay 140B measures and calculates at 1250 the system frequency (FREQ); and in FIG. 12C, the substation feeder relay 140B at 1275 measures and calculates the fundamental real (3P_F) and apparent (3S_F) three-phase power.

The calculated limits for the voltages, frequency, and total power factor were used in FIGS. 12A-12C. These power quality algorithm flow diagrams show how the power quality normal and non-normal situations were calculated. For example, in view of FIG. 12A, after collecting the VAFM, VBFM and VCFM 10-cycle average fundamentals, a respective determination is made at 1205, 1210 and 1215 to determine whether each respective VAFM, VBFM and VCFM measurement is greater than an upper threshold voltage, e.g., 7.62 kV. This determination assumes that the tested condition has endured for more than 60 seconds. For any 10-cycle average fundamental VAFM, VBFM and VCFM measurement that is found to exceed the 7.62 kV threshold limit, the process proceeds to 1220 to assert an over-voltage condition. Otherwise, if it is determined that each VAFM, VBFM and VCFM measurement is not greater than the threshold voltage, e.g., 7.62 kV, the process proceeds to respective steps 1225, 1230 and 1235 to determine whether each respective VAFM, VBFM and VCFM measurement is less than a lower threshold voltage, e.g., 6.84 kV. For any 10-cycle average fundamental VAFM, VBFM and VCFM measurement that is found below the 6.84 kV threshold limit, the process proceeds to 1240 to assert an under-voltage fault condition. Otherwise, if it is determined that each VAFM, VBFM and VCFM measurement is not less than the lower threshold voltage, e.g., 6.84 kV, the process proceeds to 1245 to assert that the measured VAFM, VBFM and VCFM values are at a normal voltage.

In view of FIG. 12B, after collecting the system FREQ value at 1250, a determination is made at 1255 to determine whether the FREQ measurement is greater than an upper threshold frequency limit, e.g., 60.3 Hz. If the calculated system FREQ is found to exceed the 60.3 Hz threshold limit, the process proceeds to 1260 to assert an over-frequency fault condition. Otherwise, if it is determined that the system FREQ value is not greater than the upper threshold frequency limit, then the process proceeds to 1265 to determine whether the system FREQ measurement is less than a lower threshold frequency, e.g., 59.7 Hz. If the system FREQ measurement is found below the 59.7 Hz threshold limit, the process proceeds to 1270 to assert an under-frequency fault condition. Otherwise, if it is determined that the system FREQ measurement is not less than the lower threshold frequency, e.g., 59.7 Hz, the process proceeds to 1272 to assert that the measured system FREQ value is normal.

In view of FIG. 12C, after collecting the system fundamental real and apparent three-phase POWER factor (3P_F, 3S_F) values at 1275, a computation is made at 1280 to determine the Power factor PF value, where PF=3P_F/3S_F. Then, at 1285, a determination is made as to whether the computed PF is less than 0.9 (when the condition has lasted at least 1 minute). If it is determined at 1285 that the computed PF is less than 0.9, the process proceeds to 1290 to assert a low-power factor fault condition. Otherwise, if it is determined at 1285 that the computed PF is equal to or greater than 0.9, the process proceeds to 1295 to assert a normal power factor condition.

In view of FIGS. 12A-12C, an overvoltage condition occurred when the nominal voltage rose above 105.8% for more than 1 min, and the undervoltage occurred when the nominal voltage dropped below 95% for more than 1 min. The frequency range was usually held within +0.5% of 60 Hz, so the measured range frequency should have been between 59.7 and 60.3 Hz. The underfrequency occurred when the frequency dropped below 59.7 Hz for more than 1 min, and overfrequency occurred when the frequency rose above 60.3 Hz for more than 1 min. The measurement of the total power factor was based on using a range between 0.9 and 1. Then, a low power factor occurred when it dropped below 0.9 for more than 1 min.

CGG system's pseudo code 2. Power quality detection code.

```
. . .
def power_factor(magTotW: float, magTotVAr: float) -> float:
  “““Returns the power factor for the given values.”””
  return magTotW / ((magTotW**2 + magTotVAr**2) ** 0.5)
def is_low_power_factor(magTotW: float, magTotVAr: float) -> bool:
  “““Returns true if the power factor is low for the given values.”””
  power_factor_threshold = 0.9
  return (power_factor(magTotW, magTotVAr)) <
  power_factor_threshold
def is_over_voltage(mag_voltage: float) -> bool:
  “““Returns true if the given voltage is over the threshold.”””
  over_threshold_kv = 7.62
  return mag_voltage > over_threshold_kv
def is_under_voltage(mag_voltage: float) -> bool:
  “““Returns true if the given voltage is under the threshold.”””
  under_threshold_kv = 6.84
  return mag_voltage < under_threshold_kv
def is_over_freq(mag_freq: float) -> bool:
  “““Returns true if the given frequency is over the threshold.”””
  over_threshold_hz = 60.3
  return mag_freq > over_threshold_hz
def is_under_freq(mag_freq: float) -> bool:
  “““Returns true if the given frequency is under the threshold.”””
  under_threshold_hz = 59.7
  return mag_freq < under_threshold_hz
```

### Electrical Fault Detection

An LL electrical fault as described hereinabove in Table 1 was simulated, and the algorithm (FIG. 10B) detected this anomaly situation by predicting the fault currents within the established limits for detecting the electrical faults. The CGG system succeeds in conveying the protective relay information and current status. The electrical fault detection was based on performing an electrical fault test. In this case, the electrical fault boundary and algorithm flow diagrams (FIGS. 10A-10B) with the event flow methods (FIGS. 6A-6B) were used. The electrical fault test was represented by an LL electrical fault at the end of distribution power line connected to breaker 424 of FIG. 4A, based on the circuit inside the use case tests area 150 of FIG. 2 but without the wind farm branches.

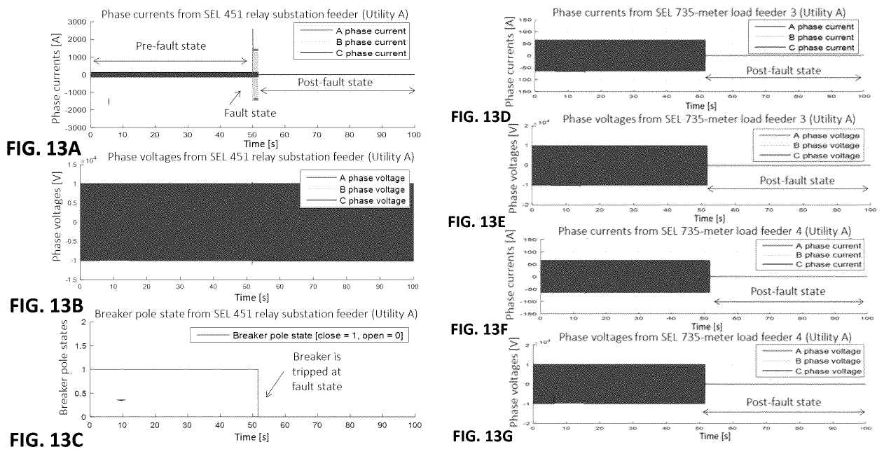

FIGS. 13A-13G shows the simulated phase currents, voltages, and pole state for the breaker 424 of FIG. 4A (e.g., a SEL 451 relay) and outside substation power meter 449 of FIG. 4B (e.g., SEL 735 power meters) in the electrical fault detection test. FIGS. 13A, 13D and 13F show simulated phase currents (A phase, B phase and C phase currents) as a function of time before a fault insertion (pre-fault insertion) and time after fault insertion (post-fault insertion); FIGS. 13B, 13E and 13G show simulated voltages (A phase, B phase and C phase voltages) as a function of time before a fault insertion (pre-fault insertion) and time after fault insertion (post-fault insertion); and FIG. 13C shows a simulated breaker pole state (e.g., for the SEL 451 relay (goID=SUB_DEV_1_FED2) for the electrical fault detection test where the braker pole is shown closed prior to the tripping at the fault state and is shown open after the breaker is tripped.

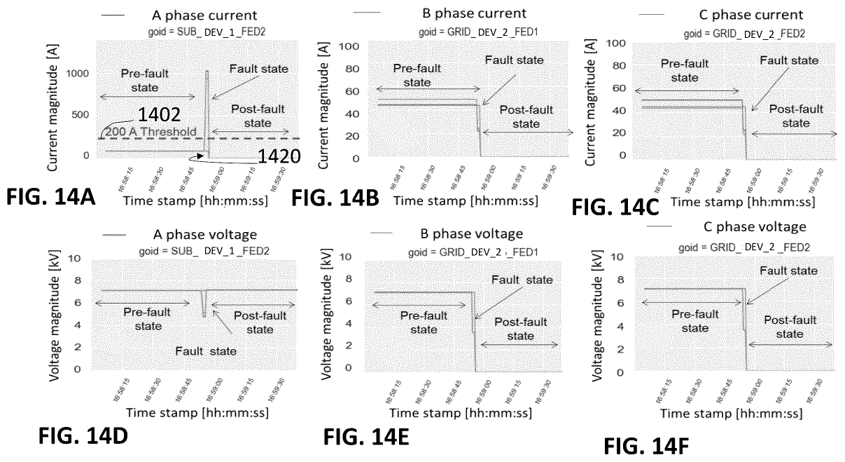

FIGS. 14A-14C show the example RMS phase currents from the example SEL 451 relay (goID=SUB_DEV_1_FED2) in FIG. 14A and SEL 735 power meters (goID=GRID_DEV_2_FED1 and goID-GRID_DEV_2_FED2) in FIGS. 14B-14C, plotted against timestamps received from the data of GOOSE messages collected from the CGG computer system for an example electrical fault detection test. FIGS. 14D-14F show the example RMS phase voltages from the example SEL 451 relay (goID=SUB_DEV_1_FED2) in FIG. 14D and SEL 735 power meters (goID=GRID_DEV_2_FED1 and goID=GRID_DEV2_FED2) in FIGS. 14E-14F, plotted against timestamps received from the data time according to the data of GOOSE messages collected from the CGG computer system for the electrical fault detection test. FIGS. 14B, and 14C show the resulting of phase currents to 0 A (post-fault state) while FIGS. 14E, 14F show the resulting of phase voltages to 0 kV (post-fault state) for the example fault.

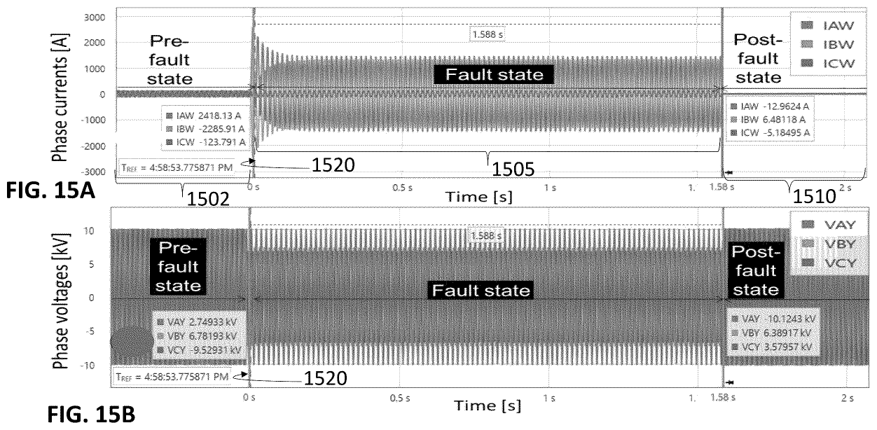

During this LL electrical fault, the CGG system observed a significant increase in the currents of phases A and B for the SUB_DEV_1_FED2 relay (e.g., breaker 424 of FIG. 4A), and a threshold of 200 A 1402 was used to detect the overcurrent electrical fault events (FIG. 14A). Once the A and B phase currents increased at the fault state (FIG. 14A), the CGG system computer detected the electrical fault, but the SEL 451 relay at breaker 424 of FIG. 4A also detected the electrical fault and tripped the breaker by clearing the electrical fault. The LL electrical fault was cleared at the postfault state, and the RMS phase currents dropped to zero at the power line and load feeders (FIG. 14A-14C). Also, the SEL 735 power meters (e.g., power meters 449 of FIG. 4B) showed how the phase voltages (FIGS. 14E and 14F) dropped to zero because the fault was cleared. FIGS. 15A-15B show the phase currents and voltages of the SUB_DEV_1_FED2 relay (e.g., breaker 424 of FIG. 4A) for the electrical fault detection test with FIG. 15A showing the three phase currents over time including pre-fault state time 1502, during fault state time 1505, and during post-fault state time 1510 and FIG. 15B showing the corresponding three phase voltages over time including during the same fault state time periods of the SEL 451 relay for the electrical fault detection test.

After running the test, the event from the example of SEL 451 relay was collected to observe the stamped time, phase currents, and voltages from the relay (FIGS. 15A, 15B) that were matched with the stamped time, phase voltages, and currents collected from the DLT system (FIGS. 14A-14D). The same time stamp 1520 for the events from the relay and the DLT system 1420 proved the synchronization of the data managed with the DLT algorithms using blockchain.

### Power Quality Monitoring

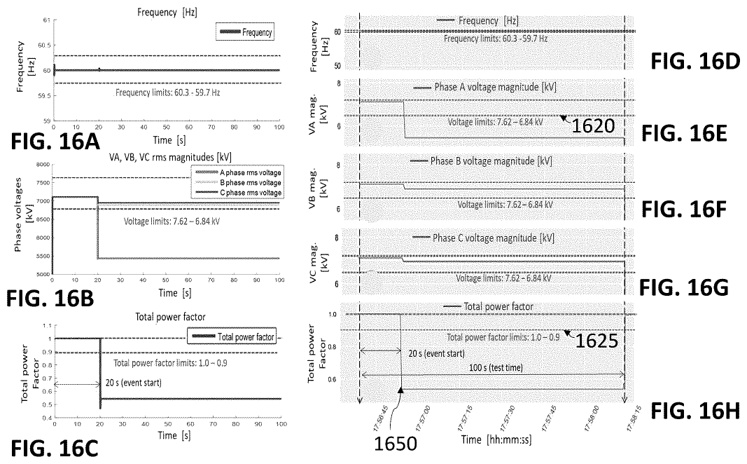

A power quality monitoring situation was simulated, and the CGG system compared the measured voltages, frequency, and total power factor with the power quality limits by predicting the power quality situation for the electrical substation main feeder. The CGG system communications were successful in conveying the protective relay measurements. The power quality monitoring was based on performing an electrical fault with a non-tripped breaker test to assess the power quality boundary (FIGS. 11A-11C) and algorithm (FIGS. 12A-12C) flow diagrams with the event flow diagram (FIGS. 6A-6B). The electrical fault test was represented by an SLG electrical fault at the end of the distribution power line connected to breaker 424 of FIG. 4A, based on the circuit inside the use case tests area 150 of FIG. 2 but without the wind farm branches. The phase A to ground electrical fault at the end of the distribution power line was set to 20 s, and the relay's breaker did not trip because the trip signal circuit was disconnected (breaker failure). This test was based on a simulation of 100 s to compare the frequency, phase voltages, and power factor within their limits for the power quality during a period greater than 60 s. FIGS. 16A-16C show: a plot of the simulated frequency as a function of time (FIG. 16A) compared to the threshold frequency limits range; a plot of the simulated phase voltages as a function of time (FIG. 16B) compared to the threshold phase voltages limits; a plot depicting the power factors as a function of time (FIG. 16C) compared to the threshold power factor limits for the breaker 424 of FIG. 4A (e.g., SEL 451 relay).

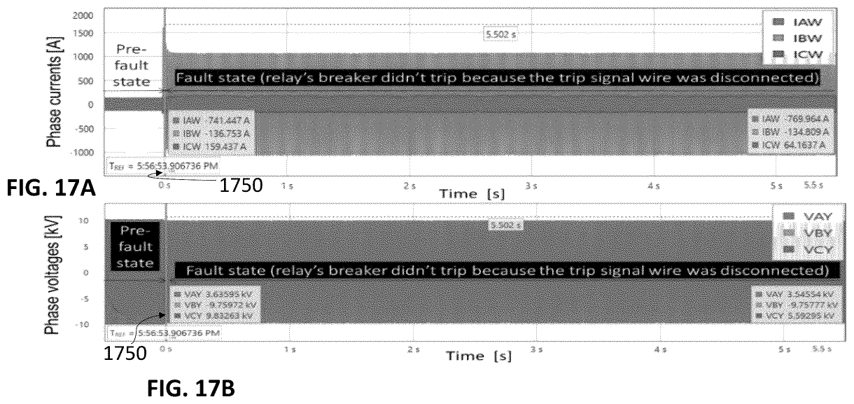

FIGS. 16D-16H depict the CGG system frequency, phase RMS voltage, and power factor of the SEL 451 relay (breaker 424 of FIG. 4A). The frequency, RMS phase voltages, and total power factor from the SEL 451 relay (GOOSE messages) were collected from the DLT computer system as shown in FIGS. 16D-16H. During the SLG electrical fault, the CGG system master node observed a significant decrease of the voltage of the phase A (FIG. 16E) and total power factor (FIG. 16H) for the SUB_DEV_1_FED2 relay (e.g., the SEL 451). The voltage of the faulted phase (phase A) was below the undervoltage limit 1620 of 6.84 kV in FIG. 16E, and the total power factor was below the low-power factor limit 1625 of 0.9 in FIG. 16H. After running the test, the event data from the relay were collected to observe the stamped time, phase currents, and voltages from the example of SEL 451 relay, as shown in FIGS. 17A-17B. In particular,

FIG. 17A shows the phase currents and FIG. 17B shows the phase voltages of the SEL 451 relay event for the electrical fault without tripping a power quality test. As shown in FIGS. 17A, 17B, the stamped time 1750 from the relay event matched with the stamped time 1650 of the events collected from the CGG computer system (FIG. 16D-16H). The same time stamp for the events from the relay and the CGG system proved the synchronization of the data managed with the algorithms using blockchain.

### DER Use Case Monitoring

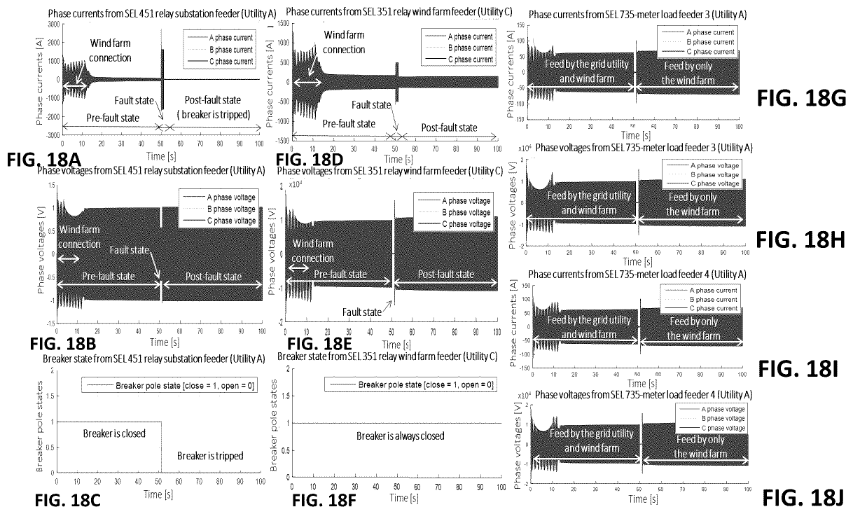

A DER use case monitoring situation with an electrical fault was simulated, and the CGG system measured the voltages and currents by predicting the islanding of the customer owned DERs (wind farm) in the electrical grid. The communications were successful in conveying the current information of the substation feeder relay and load feeder power meters. The DER use case monitoring was based on simulating the connection of the grid and wind farm during an electrical fault to assess the measurements of the wind farm feeder relay (Utility C) and electrical substation relay and load feeder power meters (Utility A). FIGS. 18A,18D, 18G and 18I show the simulated phase currents, FIGS. 18B, 18E, 18H and 18J show the simulated phase voltages, and FIGS. 18C,18F show the simulated pole states for the Breaker 424, FIG. 4A (e.g., SEL 451)/Breaker 455, FIG. 4D (e.g., SEL 351 relays) and power meter 449 (e.g., SEL 735) of FIG. 4B during the connection of the grid and wind farm with an electrical fault test.

The electrical fault test was represented by a 3LG electrical fault at the end of the distribution power line based on the use case test circuit 150 (FIG. 2) with the wind farm (Utility C) feeder connected. The 3LG electrical fault at the end of the distribution power line was set at 50 s, and the Breakers 424 and 437, FIG. 4A (e.g., SEL 451) relay tripped at both sides of the distribution power line. This test was based on a simulation of 100 s; the connection of the grid and wind farm with an electrical fault test was based on assessing the DERs use case scenario with the CGG system. Before running this simulation, the time switch 463 of FIG. 4C was set at 50 s, to control the fault block 459 (FIG. 4B), and the time switch 465 of FIG. 4C was set at 0 s, to control the islanding breaker 441 of FIG. 4B. Initially, the electrical substation (Utility A) and wind farm (Utility C) were connected to the load feeders. The 3LG electrical fault was cleared by the breaker 424 and 437 (e.g., SEL 451 relay), FIG. 4A after 50 s, and the feeder loads of the outside substation power meters 449 of FIG. 4B (e.g., SEL 735 power meter) were only fed by the wind farm (Utility C).

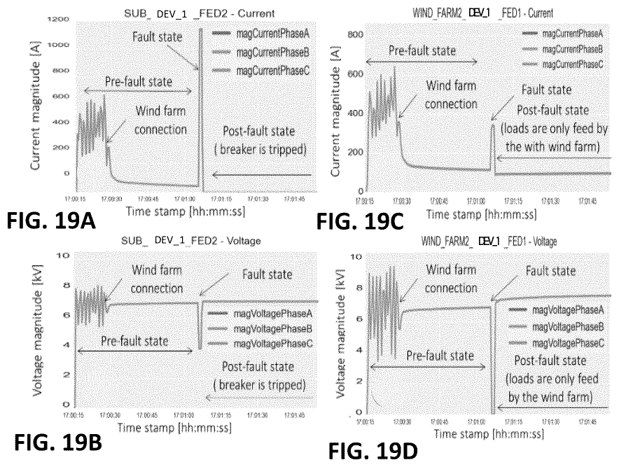

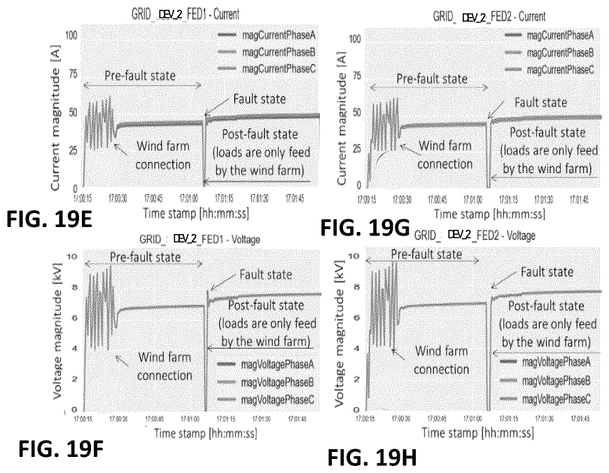

The RMS phase currents and voltages from the SEL 451/SEL 351 relays and SEL 735 power meters (GOOSE messages) were collected from the CGG system computer, as shown in FIGS. 19A-19H. In particular, FIGS. 19A, 19C, 19E and 19G depict the collected CGG system RMS phase current magnitudes, and FIGS. 19B, 19D, 19F and 19H depict the collected CGG system RMS phase voltage magnitudes from the SEL 451/SEL 351 relays and SEL 735 power meters for the connection of the grid and wind farm with an electrical fault test.

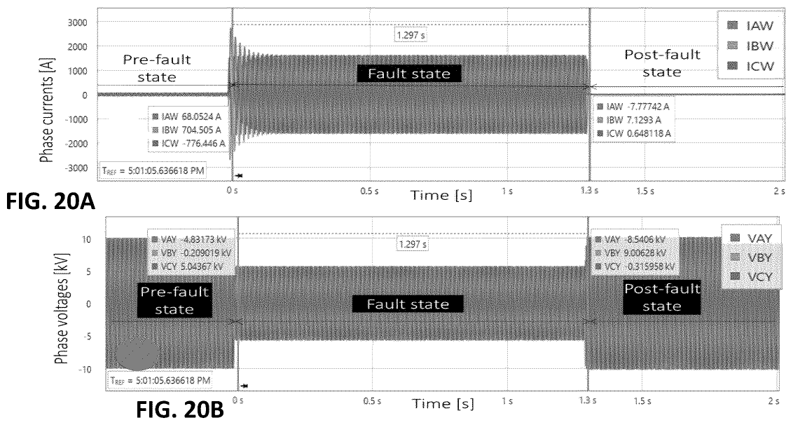

During the 3LG electrical fault, the CGG system master node observed a significant increase in the currents of the phases A, B, and C for the SUB_DEV_1_FED2 relay (e.g., SEL 451) in FIG. 19A. Once the A, B and C phase currents increased at the fault state (FIG. 19A), the SEL 451 relay detected the electrical fault and tripped the breakers 424 and 437 (FIG. 4A) at both sides of the power line by clearing the electrical fault. The RMS phase currents and voltages for the breaker 424 (e.g., SEL 451 relay) (Utility A) are shown in FIGS. 19A and 19B (e.g., SUB_DEV_1_FED2), respectively, and the RMS phase currents and voltages for the SEL 351S relay (Utility C) (e.g., WIND_FARM2_DEV_1_FED1) are presented in FIGS. 19C and 19D, respectively. The RMS phase currents and voltages from the load feeders for the SEL 735 power meters are plotted in FIGS. 19E, 19F, 19G and 19H (e.g. GRID_DEV_2_FED1 and GRID_DEV_2_FED2). The transient state (approximately 10 s) to connect the wind farm was also observed, as shown in these figures. During the 3LG electrical fault, the SEL 451 relay cleared the electrical fault, and the RMS phase currents dropped to zero at the post-fault state (FIG. 19A). Then, after clearing the electrical fault, the SEL 735 power meter loads were only fed by the wind farm feeder (Utility C), as shown in FIG. 19E (e.g., GRID_DEV_2_FED1) and FIG. 19G (e.g., GRID_DEV_2_FED2). The phase currents flowing through the breaker were controlled by the SEL 351S relay (FIG. 19C) because this breaker was kept closed. After running the test, the event from the SEL 451 relay was collected to observe the stamped time, phase currents, and voltages, as shown in FIGS. 20A, 20B.

In particular, FIG. 20A shows phase currents for the SEL 451 relay at breaker 424 (FIG. 4A) for the test with the connection of the grid and wind farm with an electrical fault test, and FIG. 20B shows the phase voltages for the SEL 451 relay event for the connection of the grid and wind farm with an electrical fault test. The phase currents, voltages, and stamped times from the relay event matched with the events collected from the CGG system computer as shown in the results of FIGS. 19A-19H. The same time stamped for the events from the protective relay and the CGG system proved the synchronization of the data managed with the algorithms.

### Cyber-Event Monitoring

A cyber-event monitoring situation was simulated, and the CGG system measured the voltages and currents from the relay and power meters. The CGG communications were successful in conveying the relay and power meter information and status. The cyber-event monitoring test was based on detecting relay setting changes by monitoring the substation feeder breaker 424, FIG. 4A from the SEL 451 relay with the CGG system and determining the relay's behavior to cyber-events.

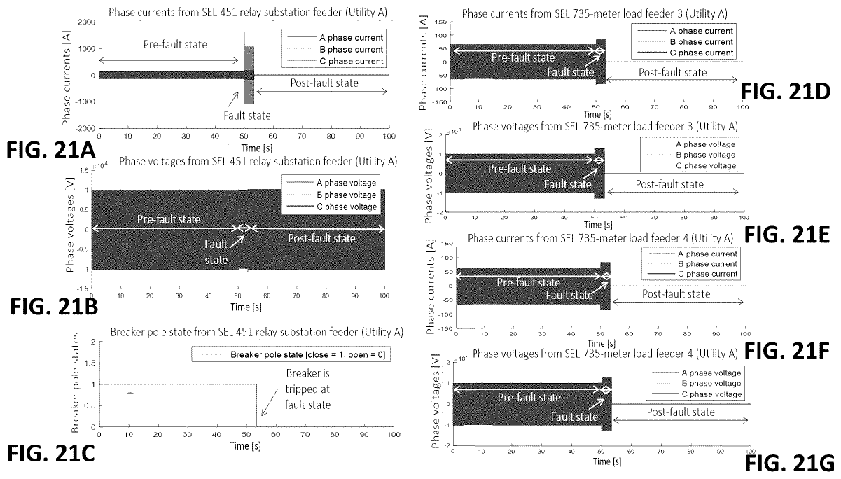

The electrical fault test was represented by an SLG electrical fault at the end of the distribution power line, based on the circuit inside the use case test area 150 (FIG. 2) but without the connection of the wind farm branches. In this case, the test was based on a combined cyber- and electrical fault event. The test was represented by phase A to ground electrical fault at the 100 T fuse feeder, and the cyber-event was the change of the current transformer ratio setting for the substation feeder relay (e.g., a SEL 451 relay) that controls the breaker 424, FIG. 4A. The test was based on a simulation of 100 s, and the SLG electrical fault was set at 50 s. FIGS. 21A-21C show the simulated phase currents, voltages, and pole states of the breaker 424, FIG. 4A from the SEL 451 relay, and FIGS. 21D-21G show the simulated phase voltages and currents of power meters 449 in FIG. 4B (e.g., SEL 735 power meter) for the combined cyber-event and electrical fault test.

In particular, FIGS. 21A, 21D and 21F depict plots of simulated phase currents versus time; FIGS. 21B, 21E and 21G depict plots of simulated phase voltages versus time, and FIG. 21C shows a plot of pole states of the breaker 424, FIG. 4A (e.g., SEL 451 relay) and power meters 449, FIG. 4B (e.g., SEL 735 power meters) for the combined CT ratio setting change with an electrical fault test.

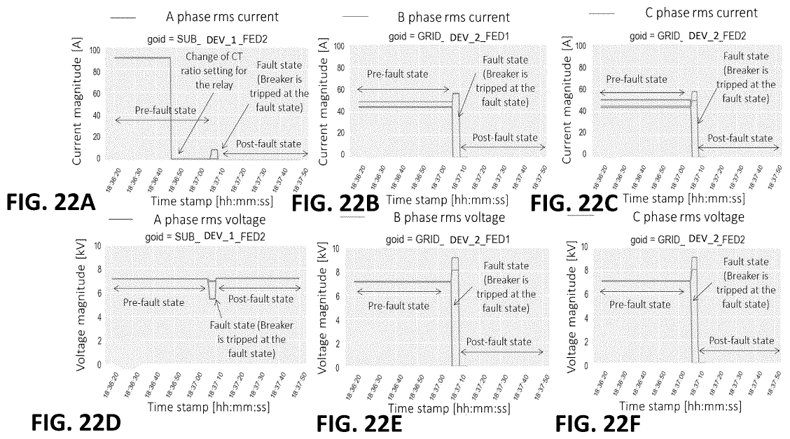

FIGS. 22A-22F show the RMS phase currents and voltages from the breaker 424, FIG. 4A (e.g., SEL 451 relay) and power meter 449, FIG. 4B (e.g., SEL 735 power meters) as GOOSE messages that were collected from the CGG system computer system. In particular, FIG. 22A shows the CGG system phase RMS current magnitudes versus time and FIG. 22D shows the CGG system phase RMS voltage magnitudes versus time from the breaker 424 of FIG. 4A.

Before the application of the SLG electrical fault, the current transformer (CT) ratio of the SUB_DEV1_FED2 relay (i.e., the breaker 424 of FIG. 4A) was changed from 80 to 1. From the CGG system, the measured RMS phase currents decreased drastically (FIG. 22A) at the prefault state.

The electrical fault affecting phase A was performed at 50 s, and the CGG system observed a nonsignificant increase in the current of phase A for the breaker 424 of FIG. 4A controlled by the SEL 45 relay (FIG. 22A) at the fault state. This situation occurred because the CT ratio of the SEL 451 relay for measuring phase currents at breaker 424 in FIG. 4A was modified. However, the SEL 451 relay tripped the breaker 424 (FIG. 4A) because the time of the inverse time overcurrent protection function depend on the injected relay phase currents instead of the CT ratio setting. The relay tripping behavior was based on Eq. (8) instead of Eq. (9). Once the phase A current increased at the fault state, the SEL 451 relay with the breaker 424 of FIG. 4A detected it, and the SEL 451 relay tripped the breaker 424 (FIG. 4A). Then, the RMS phase currents from the SEL 451 relay dropped to zero at the postfault state (FIG. 22A). The nominal phase voltages from the SEL 451 relay were measured at the postfault state (FIG. 22D). Additionally, the CGG system allowed the assessment of the RMS phase currents and voltages for the power meter locations 449, FIG. 4B (e.g., SEL 735 power meter) as shown in FIGS. 22B, 22C, 22E and 22F.

The disclosed technologies provide a CGG System based on using DLT for securing the communication network of possible cyber-attacks at power meters and protective relays in an electrical substation grid utility with customer owned DERs. Further, the disclosed technologies provide a novel electrical fault detection method using the CGG System with DLT, for discerning the faulted phases in a main feeder for different electrical faults at an electrical substation grid with DERs. Furthermore, the disclosed technologies can provide a novel power quality detection algorithm that can measure the frequency, voltage magnitudes and power factor, using a CGG System with DLT, for an electrical substation grid with DERs.

The disclosed technologies can be used in fields such as energy and utilities or manufacturing. More specifically, the disclosed technologies can be used for (1) electrical fault detection and (2) power quality monitoring algorithms, that could be implemented in an electrical substation grid utility with customer owned DERs. The disclosed technologies provide a complex and secure communication network, for sharing hashed and secure data from multiple power meters and protective relays that belong to different electrical utility sites and customer-owned wind turbine and PV array farms.

The CGG system monitored the frequency, phase voltages, and power factor. Because the RMS phase voltages need to be measured for a period of at least 60 sec. for the power quality monitoring, the communications delay time or latency should not affect the power quality monitoring, and the CGG system performs this function. Also, the monitoring of frequency during the load shedding, wind farms, and capacitor bank applications could be implemented with the CGG system to detect the over- and underfrequency situations.

The CGG system if further configurable to monitor the RMS phase currents and voltages at the DERs use case based on performing the connection of the grid and wind farm with an electrical fault. The application of the CGG system to electrical distribution utilities with customer-owned wind farms could be applied to smart energy trade and interconnection contracts between electrical utilities and DERs by using new DLT applications to improve the security between different actors. Additionally, the application of adaptive protection settings with CGG systems could be another application used to confirm the selected setting groups of protective relays between different electrical utilities.

The CGG system also performs the cyber-event test. In the combined cyber-event and electrical fault test, when the CT ratio was modified, the measured current magnitude decreased, but it did not affect the tripping of the overcurrent relay at the fault state because the relay tripped the breaker. The behavior of the breaker 424 of FIG. 4A (e.g., the SEL 451 relay) demonstrated that the relay time was calculated by Eq. (8), and a wrong setting of the CT ratio could affect the measurements but not the overcurrent tripping behavior at the fault state. This behavior is a great advantage if an engineer were to set a wrong CT ratio setting because of human error; the relay will affect the phase current measurements but not the overcurrent protection functions. The test bed can assess the protective relay's behavior for cyber-events (or cyber-security events).

The functional integrity of the CGG system that used DLT is necessary for secure power system operations. In evaluating IEDs on the electrical substation grid test bed with DERs and a CGG system, multiple advanced research applications and risks related to the network security, equipment failures, electrical hazards, and energy blackouts that could happen could be tested and/or evaluated. A means to use real power meters and protective relays with electrical substation protocols is critical to properly assess the algorithms described in the CGG system.

### Electrical Substation-Grid Testbed

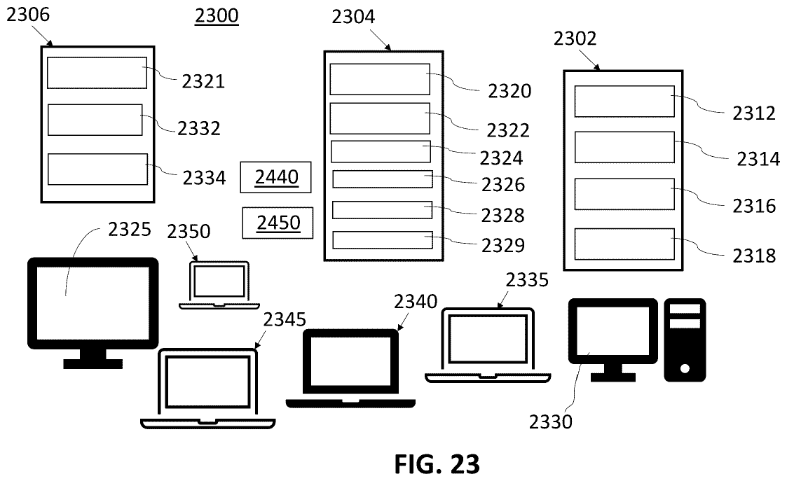

FIG. 23 conceptually depicts an electrical substation-grid “testbed” 2300 interconnection of components that simulate operations of a control center of FIG. 3 for the CGG attestation framework including the electrical substation-grid test bed and architecture used to collect and record relevant data during the simulations. As shown in FIG. 23, electrical substation-grid test bed and workstations include the operatively connected DLT control center 2306, e.g., a DLT rack implementing the DLT and communications; an inside (relays) and outside (power meters) substation devices rack 2304 representing the electrical protection and measurement system that was given by the protective relays (inside substation devices) and power meters (outside substation devices); and an electrical substation-grid rack 2302 representing the electrical substation grid including the utility source, power transformers, breakers, power lines, bus, and loads. In an embodiment, the electrical substation-grid rack of the electrical substation-grid testbed with DLT and inside/outside devices for cyber event detection includes but is not limited to, the following systems: a real-time simulator 2312, 5 A amplifiers 2314, a 1A/120 V amplifier 2316, and a power source 2318. The substation devices rack 2304 of the electrical substation-grid testbed with DLT and inside/outside devices for cyber event detection include but is not limited to, the following systems: clock displays 2320, protective relays 2322, ethernet switch 2324, power meters 2326, RTU or RTAC 2328, and other power meters 2329.

The DLT technology rack 2306 of the electrical substation-grid testbed with DLT and inside/outside devices for cyber event detection includes but is not limited to the following systems: clock displays 2321, an RTU or RTAC 2332, and SCADA display screens 2334. These components are connected to Ethernet switches 2440 and DLT devices 2450. Additionally configured, in an embodiment, is the time synchronization system given by the timing synchronized sources and time clock displays (not shown), the communication system with ethernet switches, RTU or RTAC, and firewalls, and the CGG framework with ethernet switches and DLT devices. The devices, e.g., protective relays, power meters, produced data are synchronized with the timing source (not shown).

In an embodiment, the electrical substation grid test bed has multiple computers located at desks and on the racks. One display 2325 provides the detected cyber-events using the DLT, and one display 2330 enables supervision of the real-time simulation tests with hardware-in-the-loop in the manner as described herein. The four-computer, desk-based workstations shown in FIG. 23 include a host computer 2335 running methods configured to collect currents, voltages, breaker states from tests (e.g., MATAB files), a human machine interface (HMI) computer 2340 running methods configured to collect substation inside/outside device events (e.g., COMTRADE files), a traffic network computer 2345 running methods configured to collect traffic from inside and outside substation devices based on GOOSE (IEC61850 and DNP protocols; and a SCADA computer 2350 running methods configured to collect cyber-events from DLT devices.

Various aspects of the present disclosure may be embodied as a program, software, or computer instruction embodied or stored in a computer or machine usable or readable medium, or a group of media that causes the computer or machine to perform the steps of the method when executed on the computer, processor, and/or machine. A program storage device readable by a machine, e.g., a computer-readable medium, tangibly embodying a program of instructions executable by the machine to perform various functionalities and methods described in the present disclosure is also provided, e.g., a computer program product.

The computer-readable medium could be a computer-readable storage device or a computer-readable signal medium. A computer-readable storage device may be, for example, a magnetic, optical, electronic, electromagnetic, infrared, or semiconductor system, apparatus, or device, or any suitable combination of the foregoing; however, the computer-readable storage device is not limited to these examples except a computer-readable storage device excludes computer-readable signal medium. Additional examples of computer-readable storage device can include: a portable computer diskette, a hard disk, a magnetic storage device, a portable compact disc read-only memory (CD-ROM), random access memory (RAM), read-only memory (ROM), an erasable programmable read-only memory (EPROM or Flash memory), an optical storage device, or any appropriate combination of the foregoing; however, the computer-readable storage device is also not limited to these examples. Any tangible medium that can contain, or store, a program for use by or in connection with an instruction execution system, apparatus, or device could be a computer-readable storage device.

A computer-readable signal medium may include a propagated data signal with computer-readable program code embodied therein, such as, but not limited to, in baseband or as part of a carrier wave. A propagated signal may take any of a plurality of forms, including, but not limited to, electromagnetic, optical, or any suitable combination thereof. A computer-readable signal medium may be any computer-readable medium (exclusive of computer-readable storage device) that can communicate, propagate, or transport a program for use by or in connection with a system, apparatus, or device. Program code embodied on a computer-readable signal medium may be transmitted using any appropriate medium, including but not limited to wireless, wired, optical fiber cable, RF, etc., or any suitable combination of the foregoing.

The processor(s) described herein, e.g., a hardware processor, may be a central processing unit (CPU), a graphics processing unit (GPU), a field programmable gate array (FPGA), an application specific integrated circuit (ASIC), another suitable processing component or device, or one or more combinations thereof. The storage(s) may include random access memory (RAM), read-only memory (ROM) or another memory device, and may store data and/or processor instructions for implementing various functionalities associated with the methods and/or systems described herein.

The terminology used herein is for the purpose of describing aspects only and is not intended to be limiting the scope of the disclosure and is not intended to be exhaustive. Many modifications and variations will be apparent to those of ordinary skill in the art without departing from the scope and spirit of the disclosure.

What is claimed is:

1. A system for monitoring electrical-energy delivery over an electrical grid, the system comprising:
an electrical substation grid-testbed comprising:
a simulator operable for simulating power system elements that provision of electrical energy over the electrical grid; and
one or more intelligent electrical devices (IEDs) operably connected with said simulator, said one or more IEDs receiving signals from said simulator and providing responsive measurement data signals over a communications network for storage in an off-chain database;
one or more hardware processors associated with said electrical substation grid-testbed for generating a window hash value based on a pre-determined time window of associated electrical-grid measurement data provided by said one or more IEDs and storing said generated window hash value in a ledger of a blockchain data store, the one of the hardware processor devices further communicatively coupled with the off-chain database through the communications network and are further configured to:
receive, from the off-chain database, associated electrical-grid measurement data received from the one or more IEDs and detect from said associated electrical-grid measurement data an anomalous event indicating the electrical-grid's ability to deliver electrical energy over the electrical grid; and
upon detection of an anomalous event, apply a hash function to the associated electrical-grid measurement data corresponding to said pre-determined time window from the responsive measurement data signals stored in said off-chain database to obtain a further hash value; and
compare the obtained further hash value against the generated window hash value stored in the blockchain ledger instance to confirm an integrity of the electrical substation grid-testbed communication with said blockchain data store and off-chain data storage.

2. The system of claim 1, wherein each said IED is associated with a respective power plant of the electrical grid or a respective third-party distributed energy resource (DER) functionally coupled to the electrical grid.

3. The system of claim 2, wherein said one or more hardware processors is further configured to:
establish, based on said received signals from said one or more IEDs, a key-value relationship, the key being a device identifier (ID) of an IED and the values of the key-value relationship are a list of all message data for that device ID.

4. The system of claim 3, wherein said IED comprises a protective relay or a power meter.

5. The system of claim 3, wherein said message data of the key-value relationship for that device ID comprises:
a type of function to be applied to the responsive measurement data signals associated with the IED to detect the anomalous event; and
a timestamp associated with the transmission of said responsive measurement data signals.

6. The system of claim 5, wherein said message data of the key-value relationship for that device ID comprises:
an event duration threshold period of time for which said function is to be applied to the responsive measurement data signals associated with the IED to detect the anomalous event.

7. The system of claim 5, further comprising:
an external timing source for synchronizing the power system elements simulated by said simulator, wherein a same time stamp for responsive measurement data signals obtained from the IED associated with a detected anomalous event of an IED is matched with time stamps associated with the simulating of said power system elements by said simulator.

8. The system of claim 6, wherein an anomalous event signifies one of: an electrical fault event, a power quality event, or a cyber event issue of the electrical grid.

9. The system of claim 6, wherein the detecting of an anomalous electrical fault event comprises: a check to detect a multi-cycle average overcurrent electrical fault event.

10. The system of claim 6, wherein the detecting a power quality event comprises: a check to verify if the associated electrical-grid measurement data indicates the IED output magnitude is over voltage or under voltage, over frequency or under frequency, or is of a low power factor.

11. The system of claim 6, wherein the one or more hardware processor devices is further configured to: create a dictionary that maps device ID to checks to be performed to ensure the corresponding device can be checked for anomalous event conditions.

12. The system of claim 6, wherein in response to detecting the anomalous event, causing the third-party DER to take over, from the power plant, delivering electrical energy to at least a portion of the electrical grid.

13. A method for monitoring electrical-energy delivery over an electrical grid, the method comprising:
simulating, using a real time simulator of an electrical substation grid-testbed, power system elements that provision of electrical energy over the electrical grid, the electrical substation grid-testbed having one or more intelligent electrical devices (IEDs) operably connected with said simulator;
receiving, at said one or more IEDs receiving signals from said simulator, and providing responsive measurement data signals over a communications network for storage in an off-chain database;
generating, by one or more hardware processors associated with said electrical substation grid-testbed, a window hash value based on a pre-determined time window of associated electrical-grid measurement data provided by said one or more IEDs and storing said generated window hash value in a ledger of a blockchain data store, wherein the one of the hardware processor devices are communicatively coupled with the off-chain database through the communications network:
receiving, at the one or more hardware processors, from the off-chain database, associated electrical-grid measurement data received from the one or more IEDs and detecting from said associated electrical-grid measurement data an anomalous event indicating the electrical-grid's ability to deliver electrical energy over the electrical grid; and
upon detection of an anomalous event, applying, by the one or more hardware processors, a hash function to the associated electrical-grid measurement data corresponding to said pre-determined time window from the responsive measurement data signals stored in said off-chain database to obtain a further hash value; and
comparing, by the one or more hardware processors, the obtained further hash value against the generated window hash value stored in the blockchain ledger instance to confirm an integrity of the electrical substation grid-testbed communication with said blockchain data store and off-chain data storage.

14. The method of claim 13, wherein each said IED is associated with a respective power plant of the electrical grid or a respective third-party distributed energy resource (DER) functionally coupled to the electrical grid.

15. The method of claim 14, further comprising:
establishing, by said one or more hardware processors, based on said received signals from said one or more IEDs, a key-value relationship, the key being a device ID of an IED and the values of the key-value relationship are a list of all message data for that device ID.

16. The method of claim 15, wherein said message data of the key-value relationship for that device ID comprises:
a type of function to be applied to the responsive measurement data signals associated with the IED to detect the anomalous event; and
a timestamp associated with the transmission of said responsive measurement data signals.

17. The method of claim 16, wherein said message data of the key-value relationship for that device ID comprises:
an event duration threshold period of time for which said function is to be applied to the responsive measurement data signals associated with the IED to detect the anomalous event.

18. The method of claim 16, further comprising:
using an external timing source for synchronizing the power system elements simulated by said simulator, wherein a same time stamp for responsive measurement data signals obtained from the IED associated with a detected anomalous event of an IED is matched with time stamps associated with the simulating of said power system elements by said simulator.

19. The method of claim 18, wherein an anomalous event signifies one of: an electrical fault event, a power quality event, or a cyber event issue of the electrical grid, wherein the detecting from said associated electrical-grid measurement data an anomalous electrical fault event comprises:
checking to detect a multi-cycle average overcurrent electrical fault event; and
the detecting a power quality event comprises: checking to verify if the associated electrical-grid measurement data indicates the IED output magnitude is over voltage or under voltage, over frequency or under frequency, or is of a low power factor.

20. The method of claim 18, further comprising:
creating, by said one or more hardware processor devices, a dictionary that maps device ID to checks to be performed to ensure the corresponding device can be checked for anomalous event conditions.

21. The method of claim 16, wherein in response to detecting the anomalous event, causing the third-party DER to take over, from the power plant, delivering electrical energy to at least a portion of the electrical grid.
